(19) United States
(12) Patent Application Publication
(10) Pub. No.: US 2008/0306903 A1
(43) Pub. Date: Dec. 11, 2008

(54) CARDINALITY ESTIMATION IN DATABASE SYSTEMS USING SAMPLE VIEWS

(75) Inventors: Per-Ake Larson, Redmond, WA (US); Wolfgang Martin Josef Lehner, Dresden (DE); Jingren Zhou, Bellevue, WA (US); Peter Alfred Zabback, Kirkland, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/760,203

(22) Filed: Jun. 8, 2007

(51) Int. Cl. G06F 17/30

(52) U.S. Cl. 707/2; 707/E17.017

(57) ABSTRACT

A system and method that facilitates and effectuates estimating the result of performing a data analysis operation on a set of data. Employing an approximation of the data analysis operation on a statistically valid random sample view of the data allows for a statistically accurate estimate of the result to be obtained. Sequential sampling in the view enables the approximated operation to evaluate accuracy conditions at intervals during the scan of the sample view and obtain the estimated result without having to scan the entire sample view. Feedback regarding the accuracy of the estimated result can be captured when the data analysis operation is performed against the set of data. Process control techniques can be employed with the feedback to maintain the statistical validity of the sample view.

### BACKGROUND

Advances in storage systems have allowed for the accumulation of vast amounts of data on personal computers, servers, and the internet Database systems that maintain this data are required to provide access to the data very rapidly irrespective of the amount of data being stored. In order to provide rapid access to the data, database systems perform query optimization. The goal of a query optimization is to find the most efficient way to evaluate a given query. To reliably produce efficient execution plans a query optimizer needs accurate cardinality estimates. Cardinality estimation in database systems traditionally relies on statistics, primarily single-column histograms, computed from base data or materialized views. However, this approach may produce estimates that are orders of magnitude off. Traditional estimation methods perform poorly in several situations:
1. Jagged distributions: A histogram has a limited resolution to approximate an underlying distribution. The actual distribution of data may be much more jagged than what can be represented by a histogram.
2. Complex predicates: Queries with complex predicates containing combinations of AND, OR, NOT, and IN.
3. Functions: For predicates or grouping expressions containing built-in or user-defined functions commercial database systems frequently give up and apply some “magic numbers” to come up with an estimate.
4. Correlation: Correlation among columns, in the same table or in joined tables, can have a dramatic effect on cardinalities. Traditional estimation methods assume independence between columns but, when this does not hold, estimates may be way off. Consider, for example, the predicate (COLOR=‘RED’ and PRODUCT=‘FERRARI’), where there is a high correlation between the COLOR column and the PRODUCT column.
5. Error propagation: Cardinality estimation proceeds bottom up in an expression. After combining column-wise estimates to compute the number of rows coming from a single table, the local cardinalities are combined and propagated up to the root operator. For large queries, the errors produced by this propagation process can become extremely large.
6. Stale statistics: If the underlying data changes, a histogram may need to be refreshed to accurately reflect the data. Current policies for triggering refresh of statistics are usually heuristic and not based on sound statistical criteria and thus may result in stale statistics or unnecessarily frequent updates. Another reason for incorrect statistics may be that they were computed from a poor (non-random) sample of the data.

There is a need to provide accurate cardinality estimates even under the above described circumstances.

### SUMMARY

The following presents a simplified summary in order to provide a basic understanding of some aspects of the disclosed subject matter. This summary is not an extensive overview, and it is not intended to identify key/critical elements or to delineate the scope thereof. Its sole purpose is to present some concepts in a simplified form as a prelude to the more detailed description that is presented later.

In accordance with one or more aspects and corresponding disclosure thereof, various features are described in connection with utilizing random sampling and materialized view technologies to produce accurate estimates of cardinality, results of data queries, and data analyses. In one aspect, a random sample of the data output by a view expression is included in a sample view. During query optimization regular view matching is performed and may find that a subexpression of a query matches a sample view. If so, a probe query is executed against the sample view to estimate the cardinality of the subexpression result when executed against the entire data output from the view expression. To further reduce the time required to estimate the cardinality, the probe query can be executed against a sub-sample of the sample view, provided that the sub-sample meets minimum requirements, such as accuracy requirements for the cardinality estimate and/or size requirements. In another aspect, the sub-sample can be constructed based on sequential sampling by means of assigning a random identifier to each data row in the original sample of the view and sorting the data rows by the random identifier. The probe query can then be executed against the sequentially ordered sample, stopping as soon as the minimum accuracy and/or size requirements has been reached, and outputting the cardinality estimate. The execution plan for the query can then be optimized based at least partially upon the cardinality estimate thus obtained.

Another aspect involves employing feedback from queries to assure the quality of the cardinality estimates. When a query is executed, the actual cardinality of a subexpression can be easily determined and the estimation error computed. After error normalization, statistical process control techniques can be applied to the stream of observed errors to determine when the estimates used no longer are statistically accurate and a refresh of the sample view is needed. The process control techniques can employ a cost-benefit analysis with regards to availability of system resources and/or time required to refresh in relation to accuracy of the cardinality estimate.

Many times large quantities of data must be analyzed in order to understand certain aspects of the data using data analysis operation that are not easily implemented via database query languages. Approximate query answering is another aspect of the invention where sample views can be employed to approximate the answer to a query or data analysis. The query or data analysis can be run against the sample view to approximate the result that would be achieved by running the query or data analysis against the entire data output from the view expression. The approximate result can be provided to the user much more rapidly than an exact result based on the complete set of data.

In another aspect, sample views can augment or replace conventional cardinality estimation. Probe queries increase query optimization time. The time utilized by probe queries doesn't much matter for expensive queries that run for several seconds or even minutes, but it may be too high for very cheap queries. Therefore, a determination can be made by the system based upon factors related to the query type of when to utilize probe queries with sample views.

To the accomplishment of the foregoing and related ends, certain illustrative aspects of the disclosed and claimed subject matter are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a machine-implemented system that employs sample views to estimate cardinality.

FIG. 2 illustrates an execution plan for a probe query under sequential sampling.

FIG. 3 illustrates an execution plan for a probe query with aggregation under sequential sampling.

FIG. 4 illustrates an example of the execution of the probe query from FIG. 3.

FIG. 5 illustrates a machine-implemented system that employs sample views to estimate cardinality.

FIG. 6 illustrates a machine implemented system employing sample views to estimate the results of a data analysis operation.

FIG. 7 illustrates a flow chart of one methodology for employing random sampling and materialized views to estimate cardinality.

FIG. 8 illustrates a flow chart of one methodology for creating a sample view.

FIG. 9 illustrates a flow chart of one methodology for employing probe queries with sample views to estimate the cardinality of a query.

FIG. 10 illustrates a flow chart of one methodology for providing feedback on actual cardinalities for executed queries.

FIG. 11 illustrates a flow chart of one methodology for employing process control techniques to initiate an update to a sample view.

FIG. 12 illustrates a query plan generated by an optimizer based on an incorrect estimate.

FIG. 13 illustrated a query plan generated by an optimizer based on an a cardinality estimate based on sample views.

FIG. 14 illustrates the normalization process for two different predicates, one with selectivity 10% and one with selectivity 55%.

FIG. 15 illustrates the quality control mechanism in operation for a sudden change of data.

FIG. 16 illustrates how the actual selectivity of the query predicate slowly changes as base data is updated.

FIG. 17 illustrates a sample refresh is initiated by putting the sample view into refresh pending mode and creating a low-priority back-ground job to carry out the refresh.

FIG. 18 illustrates how selectivity changes are reflected in the control variable zᵢ, that is, in the input to the control system.

FIG. 19 illustrates how the system responds to a sudden change that is large enough to cause all feedback to be mapped into z-values of one.

FIG. 20 illustrates the response to a gradual change in data and how it depends on the sample size.

FIG. 21 illustrates a block diagram of a computer operable to execute the disclosed sample view based estimation architecture.

FIG. 22 illustrates a schematic block diagram of an exemplary computing environment for processing the sample view based estimation architecture in accordance with another aspect.

### DETAILED DESCRIPTION

The subject matter as claimed is now described with reference to the drawings, wherein like reference numerals are used to refer to like elements throughout. In the following description, for purposes of explanation, numerous specific details are set forth in order to provide a thorough understanding thereof. It may be evident, however, that the claimed subject matter can be practiced without these specific details. In other instances, well-known structures and devices are shown in block diagram form in order to facilitate a description thereof.

As used herein, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers.

Throughout the discussion below, experimental results based on exemplary sets of data are presented to further support or illustrate various aspects of the subject application. It should be appreciated and understood that such experiments are not intended to limit the scope of the systems and methods described herein to particular scenarios, operating conditions or applications but are provided as examples. Moreover, the subject application can be employed with respect to any type of searching and/or data analyses performed on the Internet, on a remote or local server, storage facility, or on any computing device or network.

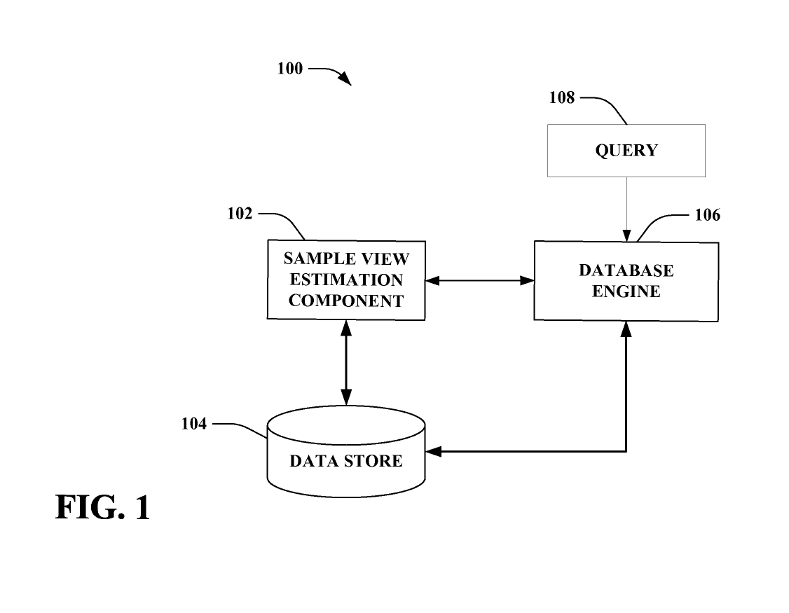

Referring to FIG. 1, there is illustrated a general block diagram system 100 employing random sampling and materialized views to estimate cardinality. System 100 includes sample view estimation component 102 that maintains random samples of data output from view expressions evaluated against data store 104 by database engine 106 to produce sample views. During optimization of a query 108, the database engine 106 may find a match of query 108 against a sample view maintained by the sample view estimation component 102. The view expression can be related to the entire query 108 or a subexpression of query 108. The sample view estimation component 102 may then construct and issue a probe query against the matching sample view whose result can then be used to estimate the cardinality of the expression. For a single query 108 there can also be multiple sample views each relating to a subexpression of query 108.

In one aspect, sample views contain simple random samples, for example, created by Bernoulli sampling in order to be able to apply a large class of estimators. When the view expression is evaluated, each output row is randomly selected for inclusion in the sample with a specified probability. Hence, the actual percentage of rows in the sample may be slightly different than specified. The total number of rows in the view and number of rows in the sample view are recorded in the database system's catalog.

A sample view can be defined in the same way as a regular materialized view with the same restrictions applying. The view definition may contain any predicates, except sub-queries in the WHERE clause, and may include grouping expressions in the GROUP-BY clause. The general form of a view definition is as follows.

CREATE VIEW <svname> WITH SCHEMABINDING AS
SELECT <keycols>, ...
FROM ...
[WHERE ...]

It is likely, but not required, that a sample view will contain only joins and no further restrictions because such a view is more versatile than a view with restrictions. Similarly, the more columns the sample view outputs, the more broadly useful is the sample view.

Like a regular materialized view, the rows of a sample view are materialized when a unique clustered index is created on the view. The clustering index can be defined as follows.

CREATE UNIQUE CLUSTERED INDEX <clidxname> ON
<svname> (<keycols>) [ROWSAMPLE <samplepercent> PERCENT]

The ROWSAMPLE clause marks the view as a sample view and prevents it from being used as a regular materialize view. The parameter <samplepercent> specifies what fraction of the view to include in the sample and <keycols> identifies the columns one which to cluster the rows.

The following example creates a 2% sample view over the join of lineitem and orders with a receipt date during 1993.

```
CREATE VIEW SV_LINEITEM_ORDERS WITH SCHEMABINDING
AS SELECT L_ORDERKEY, L_PARTKEY, L_SUPPKEY,
L_LINENUMBER,...
    O_ORDERSTATUS, O_TOTALPRICE, O_ORDERDATE, ...
FROM TPCD.LINEITEM, TPCD.ORDERS
WHERE L_RECEIPTDATE BETWEEN ’1993-01-01’ and ’1993-12-31’
  AND L_ORDERKEY = O_ORDERKEY;
CREATE UNIQUE
CLUSTERED INDEX SV_LINEITEM_ORDERS_CLIDX ON
  SV_LINEITEM_ORDERS (L_ORDERKEY, L_LINENUMBER)
  ROWSAMPLE 2 PERCENT
```

Now assume that, during query optimization, a sample view is found to match a query subexpression. The view matching procedure will return the name of the matching view and a residual predicate which, when applied to the view expression, yields an expression that is equivalent to the matched query subexpression. The view name and residual predicate can then be used to construct a probe query. If the entire sample view is scanned, then an example probe query that can be constructed by sample view estimation component 102 is the following:

SELECT COUNT(*) AS n_p FROM <view name> WHERE <pred>

Where <pred> is the placeholder for the residual predicate, <view name> is the name of the sample view, and n_p is the number of rows that satisfy the residual predicate. The sample size Nₛ is available in the catalog so an estimate of the fraction of rows satisfying the residual predicate can be computed as [symbol] =n_p/Nₛ. The total size of the view, Nᵥ, is also available in the database catalog so the cardinality of the expression can be estimated as [symbol] Nᵥ

Executing a probe query during query optimization increases the optimization time but the overhead can be reduced greatly by using sequential sampling. In sequential sampling only as many rows of the sample as is needed to compute a sufficiently accurate estimate are processed. In many cases, only a small subset of the rows is needed to reach a desired accuracy.

Optionally, sample view estimation component 102 assigns a random value to each row contained in the sample so as to enable the use of sequential sampling. For example, the internal representation of a sample view can contain an additional column _{—}_RAND of type short int. This column holds a random value drawn from a uniform distribution in the range [0; MAXRAND].

Sample views automatically add the _{—}_RAND column as the first key column to physically store the rows sorted on the random value. That is, internally the clustering index is defined as:

CREATE CLUSTERED INDEX <clidxname> ON
<svname> (_RAND, <keycols>)

Adding the _{—}_RAND column as the leading column of the key makes it possible to apply sequential sampling on the sample view. Rows containing the same _{—}_RAND value are clustered together. If a sequential scan of the sample is terminated at the end of such a cluster, the set of rows scanned is a statistically valid, simple random sample. However, this cannot be guaranteed if the scan is terminated within a cluster. Within a cluster the rows are sorted on <keycols> and the ordering may be correlated with selectivity. For example, rows early in the cluster may be more likely to satisfy the query predicate than rows later in the cluster.

Probe queries can be constructed by the sample view estimation component 102 that evaluate a stopping condition at every change in value in the sorted _{—}_RAND column, and terminate the scan as soon as the condition is satisfied. One example of a stopping condition is whether the standard error of the cardinality estimate is within a specified range. In addition, two additional stopping conditions can be: ensuring that an estimate (possibly the latest computed cardinality estimate, or one based upon a default algorithm/function or pre-defined value) is returned when the whole sample has been scanned (even if the desired accuracy has not been reached); and ensuring that the estimate is based on a minimal set of evidence. The minimal set of evidence can be based upon a predefined minimum number of rows that is numerically defined or defined by an algorithm/function. For both additional stopping conditions, the algorithm/function can be based upon factors associated with the query, the size of the sample, the required accuracy, user definition, or any other appropriate factors.

Evaluating complex stopping conditions very frequently can be expensive. To overcome this, values for the random identifier can be generated by sample view estimation component 102 from a small set of values and the probe queries only test the stopping condition once for each cluster of rows with the same random identifier value. For example, generating values in the range [1,100] means that the stopping condition is evaluated at most 100 times. Additionally, to enable sequential sampling, execution plans for probe queries cannot contain any blocking operators (such as a sort), that is, operators that consume the whole input before producing output tuples.

Sample view estimation component 102 can estimate the cardinality for query 108 or subexpressions of query 108 by employing one or more sample views and their respective probe queries. Where a sample view and/or probe query does not exist for a query expression or query subexpression, a sample view and/or probe query can be created as described above. Where cardinality estimates for multiple query subexpressions of query 108 are produced, a cardinality estimate for query 108 is produced by combining the cardinality estimates for the query subexpressions using any appropriate algorithm.

In one example, sample view estimation component 102 estimates the cardinality for query expression E without aggregation as follows. Expression E may represent the entire query 108 or a subexpression thereof. Expression E=σₚ_{_{q}}(T₁× . . . Tₙ) matches a sample view defined by V=σₚ_{ᵥ}(T₁× . . . Tₙ) if and only if p_{q} [symbol] pᵥ, that is, every row that satisfies the query predicate p_{q} also satisfies the view predicate pᵥ. If this is the case, the view matching procedure returns a residual predicate pᵣ with the property that p_{q}=pᵣ [symbol] pᵥ. If the view is fully materialized, query expression E can then be computed from the view by the substitute expression E=σₚ_{ᵣ}V. The sample is used to estimate the cardinality of the expression σₚ_{ᵣ}V, which is an estimate of the cardinality of the original query expression σₚ_{_{q}}(T₁× . . . Tₙ).

Provided the view outputs all columns referenced in pᵣ, the probe query σₚ_{ᵣ}V can be run against the whole sample or any random subset thereof. If the probe query is run on a subset containing nₛ rows (nₛ≦Nₛ where Nₛ is the total number of rows in the sample view) and nₚ rows satisfy the residual predicate pᵣ, then an estimate of the selectivity of predicate pᵣ is [symbol] =nₚ/nₛ with an estimate of the standard error of [symbol] =\sqrt{ [symbol](1− [symbol] /nₛ)}. The cardinality of E can then be estimated as Card(E)= [symbol] Nᵥ, where Nᵥ is the total number of rows output from the view expression, with an estimated standard error of [symbol] = [symbol] Nᵥ.

Where sequential sampling is employed, a more complex probe query is needed because the query must return both the number of rows scanned and the number of rows satisfying the predicate, use a sequential scan, and terminate as soon as the desired accuracy has been reached. For example, a probe query under sequential sampling can be constructed as follows.

```
SELECT TOP(1) SUM(t2.cnt_p) AS n_p,
      SUM(t2.cnt_all) AS n_s
FROM (SELECT _RAND,
    SUM(t1.cnt_p) AS cnt_p, COUNT(*) AS cnt_all
  FROM (SELECT _RAND,
      CASE WHEN <pred> THEN 1 ELSE 0 END AS cnt_p
    FROM <view name> ) t1
  GROUP BY _RAND) t2
GROUP BY ALL WITH STEPWISE
HAVING <stopping condition>
OPTION (ORDER GROUP)
```

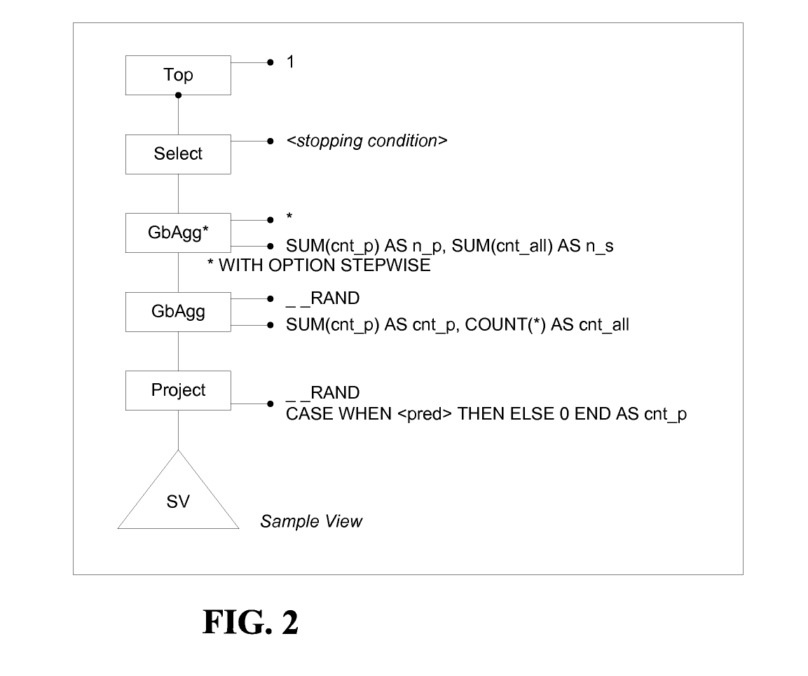

The execution plan generated for this query is shown in FIG. 2. The first (lowest) operator Project evaluates the residual predicate and sets column cnt_p to one if it is satisfied and otherwise to zero. The second operator GbAgg performs a preaggregation by counting the overall number and the number of qualified rows for the same _{—}_RAND value. Since the sample view is sorted on the _{—}_RAND column, aggregation can be done by a streaming aggregate operator that outputs a row as soon as a change in _{—}_RAND values is encountered. The purpose of the preaggregation is to reduce the number of times the stopping condition is evaluated. The third operator GbAgg* performs the final aggregation by summing up the partial results cumulatively from GbAgg. The group-by operator runs with option stepwise enabled, which causes the operator to generate an output row with the current state of the aggregate values for every incoming row. Since the scalar aggregation in this particular setup does not specify any grouping columns, we use the keyword ALL as a place-holder. The Select operator applies the stopping condition as specified in the HAVING clause of the probe query. The Top operator closes the scan after having output one row. This row is the first row produced that satisfies the stopping condition and is the cardinality estimate for the view expression.

The stopping condition, for example, can require that a certain minimum number of rows be read to have enough evidence. Once this number has been reached, scanning stops as soon as one of the following three example criteria is satisfied.
1. Relative Error: the 95% confidence interval is less than 10% of the point estimate.
2. Absolute Error: the estimate number of qualifying rows (in the real data set) is 10 or less with 90% confidence.
3. End of sample: the end of the sample is reached.

This probe query and execution plan meets the goals stated above. The stopping condition is evaluated only after combining sample rows that have the same _{—}_RAND value. The step-wise option causes the grouping operator to output its running results. The final top operator shuts down the probe query as soon as an estimate with acceptable accuracy is available.

In another example, sample view estimation component 102 estimates the cardinality for query expression with aggregation as follows. Consider a query expression E=γ_{G}^{A}σₚ_{_{q}}(T₁× . . . Tₙ) and a (sample) view defined by V=σₚ_{ᵥ}(T₁× . . . Tₙ). The notation γ_{G}^{A} specifies grouping with grouping expressions G and aggregation functions A. If the view matches, both further selection and further aggregation may be needed. View matching returns, in essence, the operators γ_{G}^{A}σₚ_{ᵣ}. If the view were fully materialized, query expression E could be computed from the view as E=γ_{G}^{A}σₚ_{ᵣ}V. We use the sample to estimate the cardinality of the expression γ_{G}^{A}σₚ_{ᵣ}V, which also is an estimate of the cardinality of the original query expression γ_{G}^{A}σₚ_{_{q}}(T₁× . . . Tₙ).

Estimating the cardinality of γ_{G}^{A}σₚ_{ᵣ}V is the same as estimating the number of distinct values occurring in the result of π_{G}σₚ_{ᵣ}V. This is a statistical estimation problem, originally formulated as estimating the number of species in a population, and many different estimators have been utilized to address this problem. Three estimators have shown themselves to be more robust in experimentation: Chao's estimator, Shlosser's estimator, and the Poisson estimator. However, any estimator may be employed that is appropriate to the query and data being evaluated. A probe query can be employed that returns data needed by a variety of operators, allowing for the freedom to decide on an appropriate estimator or combination of estimators. Virtually all distinct-value estimators take as input value pairs consisting of (group size, number of groups of that size) computed from the sample. The probe query can return this information in a single tuple in order to support sequential sampling and terminate as soon as a sufficiently accurate estimate is returned.

The following probe query outputs the data needed by many distinct-value estimators. <pred> is the residual predicate and <grp-list> is a placeholder for the list of grouping columns returned by view matching. PICKPIVOT is a fixed small table.

```
SELECT TOP(1)
    SUM(t2.grpcard) AS dvcard,
    SUM(t2.grpcard * t2.grpsize) as scard
    SUM(t2.grpcard * p.flag1) AS grp1card,
    ...,
    SUM(t2.grpcard * p.flagn) AS grpncard
FROM (SELECT smplsize, t1.grpsize, COUNT(*) AS grpcard
    FROM (SELECT INPUTCOUNT() as smplsize, <grp-list>,
            COUNT(*) AS grpsize,
        FROM <svname> WHERE <pred>
        GROUP BY <grp-list> WITH OPTION FLUSH(_RAND)
        OPTION (HASH GROUP)) t1
    GROUP BY smplsize, t1.grpsize
    OPTION (ORDER GROUP)) t2,
    PICKPIVOT pt
WHERE t2.grpsize = pt.id
GROUP BY smplsize
HAVING <stopping condition>
```

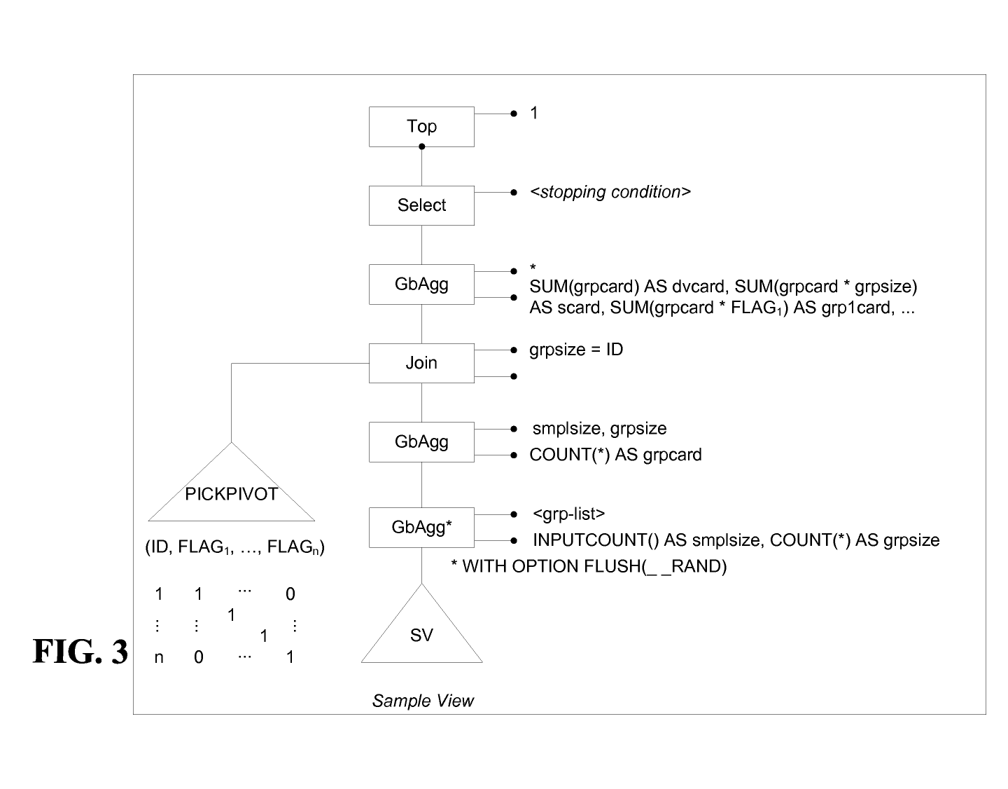

The execution plan generated for this probe query is shown in FIG. 3. The lowest operator GbAgg* computes the group size for different group expression values within each partition defined by the _{—}_RAND value. Similar to the option step-wise for sort-based aggregation, an option FLUSH(<column list>) is added to the hash-based aggregation operator. When option FLUSH is enabled, the operator performs its normal aggregation and, in addition, outputs the current state of aggregation whenever the value of the FLUSH indicator columns <column list> changes (but does not otherwise change the state). The function INPUTCOUNT( ) returns the number of input rows consumed so far by the operator. This value is included in every output row so we can tell which tuples originate from the same subsample.

The second aggregation operator GbAgg simply counts the number of groups of each size. At this point the needed result is obtained. However, the result consists of multiple rows and the result is needed in a single row. To accomplish this, the result is pivoted. The next two operators Join and GbAgg perform the pivoting using, for example, the Rozenshtein method. The Join operator joins the result with a static table PICKPIVOT that consist of n rows with an ID column and n additional columns, labeled FLAG₁, FLAG₂, through FLAGₙ. Row i, i=1, 2, . . . n has the value i in the ID column, one in column FLAGᵢ, and zero in all other columns. The join extends each row with n flag columns and column FLAGᵢ contains a one if the row represents groups of size i. The group-by operator GbAgg completes the pivoting by constructing a single output row for each sample size.

The pivot step collected all the group cardinalities together, producing a single row for each sample size. The stopping condition is then evaluated to determine whether an estimate meeting the accuracy can be computed. The TOP operator closes the query after outputting the first row satisfying the stopping condition.

In the same way as for non-aggregation, stopping conditions for distinct-value estimation can be tied to the estimate's confidence interval. However, the calculations required to compute confidence intervals for general distinct-value estimators like Shlosser's estimator or jackknife-style estimators can be complex. In one example, a stopping condition that combines two factors is employed.
1. Confidence interval of Poisson estimator: As long as the sample is a small fraction of the population, the Poisson estimator generally provides a stable estimate and its confidence intervals are relatively easy to compute. Hence, our first stopping condition is that the 95% confidence interval of the Poisson estimator is less than 10% of its point estimate.
2. Distance between Chao and Shlosser estimator: The Chao estimator is a lower-bound estimator while the Shlosser estimator tends to overestimate the actual value. For larger sampling fractions, scanning stops when the (relative or absolute) difference between these two estimates becomes less than a target value.

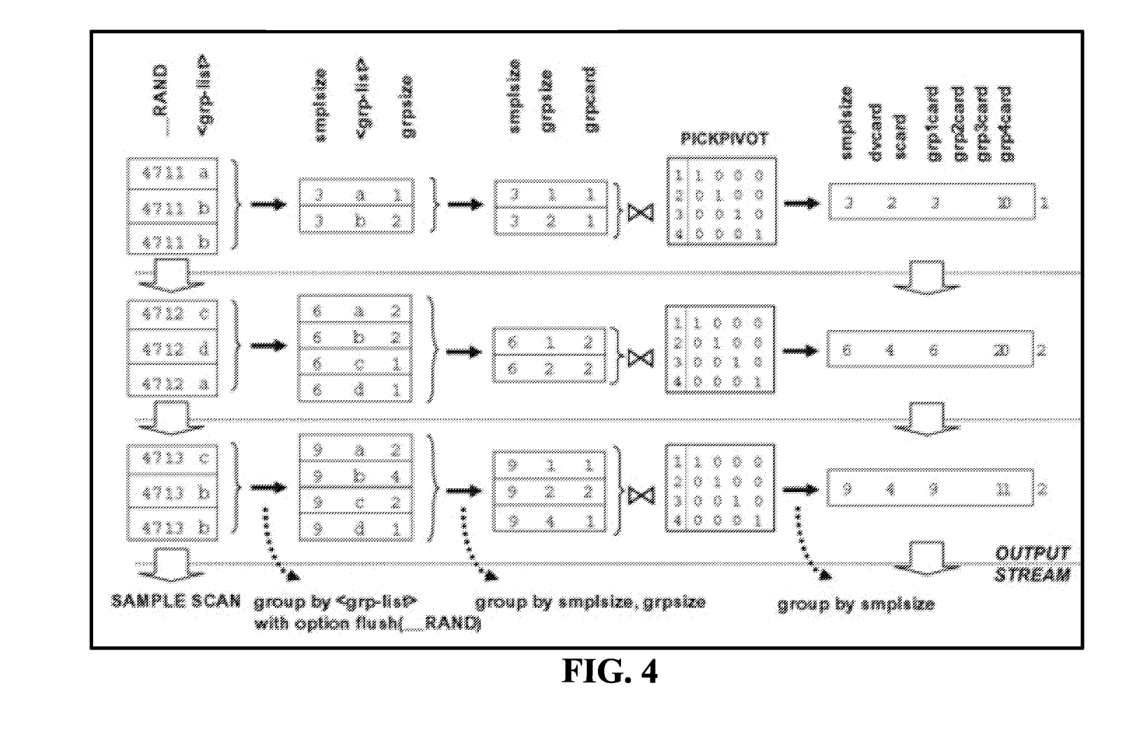

FIG. 4 illustrates an example of the execution of the probe query from FIG. 3. When the _{—}_RAND column changes from 4711 to 4712, the first group-by operator outputs two rows, (3,‘a’,1) and (3,‘b’,2). There are two groups, one of size one and one of size two, so the second group by operators outputs two rows, (3,1,1) and (3,2,1), which the pivoting combines into a single row. Scanning continues with the next cluster of rows, with _{—}_RAND value 4712, and adds them to the existing state of the first group-by operator. When the end of the cluster is reached, there are two groups of size 2 and two groups of size one. The operator outputs two rows, (6,1, 2) and (6,2,2), which again are combined into a single row by the pivoting. This process continues until the stopping condition is satisfied by a row produced by the pivoting operation. Sample view estimation component 102 outputs the first row from the pivot operation that satisfies the stopping condition and stops the probe query.

Sample view estimation component 102 utilizes the outputted row that satisfied the stopping condition to provide a cardinality estimate for query 108 when executed. Database engine 106 employs the cardinality estimate in creating an optimized execution plan for query 108.

In order to produce accurate cardinality estimates, a sample view must contain a statistically valid random sample of the results of the view expression. As the data in the underlying database tables changes, the statistical validity of the sample view must be maintained. In one aspect, the sample view is maintained in the same manner as regular materialized views, which are maintained incrementally. However, in some cases this approach can significantly increase utilization of system resources, as in the following cases:
1. When the view consists of multiple joins.
2. Incremental view maintenance is performed as part of the update transaction. The presence of sample views would then impact overall system load, even during peak times.

In another aspect, the sample view can be fully refreshed only when required. Feedback from running queries can be used to check whether cardinality estimates computed from the sample view are still within statistical error bounds. Maintenance of the sample view is then deferred as long as the sample view statistically still represents the underlying data. Database engine 106 can provide feedback to sample view estimation component 102 of the actual cardinality for each query expression or query subexpression that results each time a query 108 is executed. The actual cardinalities can be stored with the corresponding cardinality estimate for query 108. In an example, a sample view may have many different queries 108 returning feedback, some with low selectivity and some with high selectivity. Cardinality estimation errors from different queries 108 cannot be be compared directly but must first be converted to a common scale. In this way, the sample view receives a stream of normalized cardinality estimation errors during query execution. Sample view estimation component 102 can apply standard statistical process control techniques to the stream of normalized errors to detect when the errors are no longer within statistical bounds and trigger a refresh of the sample view.

In one example, during optimization of a query, the cardinality of some subexpressions Eᵢ, where i is the number of the subexpressions, of the query may be estimated from a matching sample view. Where a sample view does not exist for a subexpression Eᵢ, a sample view could be created. Some, not necessarily all, of those subexpressions Eᵢ may be present in the final execution plan. Each such subexpression Eᵢ reports back to its sample view the actual number of rows resulting each time the subexpression is executed so the accuracy of the cardinality estimate can be assessed. When a cardinality estimate for a subexpression Eᵢ is computed from a sample view, an InfoPack structure is associated with the subexpression Eᵢ and all expressions equivalent to Eᵢ. If Eᵢ or any expression equivalent to Eᵢ appears in the final query execution plan, InfoPack is associated with the operator in the execution plan that corresponds to the root of Eᵢ. During execution, the database engine 106 counts the number of tuples the operator outputs and, provided that it has a valid count at the end, uses the information in the InfoPack to report back the count for the appropriate sample view to sample view estimation component 102. In an example, the InfoPack structure contains the following fields:
1. an identifier for the sample view used to compute the cardinality estimate
2. a version number of the sample view used
3. a flag indicating the type of estimator used
4. the estimated number of rows that will be produced by the operator, \hat{K}
5. the actual number of rows produced by the operator, K, (filled in after execution)
6. the number of rows from the sample read by the probe query, n

If the operator has a valid row count when execution finishes, the actual cardinality is filled in by the database engine 106 and the InfoPack is passed to sample view estimation component 102. A row count is not valid unless the operator has seen the end of input, which it may not do if, for instance, the query is terminated early by a user or by a Top operator.

In an aspect, sample view estimation component 102 normalizes the feedback received for each sample view. Let S denote a random sample of size n drawn from the result of view V (population) with Nᵥ rows (Nᵥ [symbol] n). The cardinality estimate \hat{K} is a function of S, that is, \hat{K}=fₑ(S) where fₑ is the estimator function. K is a stochastic variable with a well-defined probability density function (pdf) that depends on the estimator fₑ and the sampling scheme. An example sampling scheme is simple random sampling with samples of size n that are drawn from a population of size Nᵥ. Denote the probability density function of K for this scenario by P(\hat{K}=x)=g_{f}_{ₑ}(x, n, Nᵥ) and the cumulative density function (cdf) by P(\hat{K}≦x)=G_{f}_{ₑ}(x, n, Nᵥ).

As queries execute, sample view estimation component 102 receives a stream of actual cardinalities corresponding to estimates computed from view V for each query 1 . . . i, i being an integer. In one aspect, the stream received denoted by R₁, R₂, . . . . Rᵢ is not a simple value but a tuple consisting of (Kᵢ, \hat{K}ᵢ, fᵢ, nᵢ) where Kᵢ is the actual cardinality, \hat{K}ᵢ is the estimated cardinality, fᵢ indicates which estimator was used, and nᵢ is the sample size used when computing the cardinality estimate.

In the case where the estimation errors are based upon the same estimator and same sample size, the errors can be computed as \hat{K}ᵢ−Kᵢ. However, when the estimates are based on different estimators and different sample sizes, the errors from each query must be normalized. In this case, the errors are converted to a common scale by mapping \hat{K}ᵢ through the estimator's fᵢ cumulative density function, that is, ŷᵢ=G_{f}_{ᵢ}(\hat{K}ᵢ, nᵢ, Nᵥ). Because the mapping is through the estimator's cdf, ŷᵢ is, by definition, uniformly distributed in [0, 1] with expected value E(ŷᵢ)=0.5 and variance S²(ŷᵢ)= 1/12. If the estimator is unbiased, then G_{f}_{ᵢ}(Kᵢ, nᵢ, Nᵥ)=0.5. The normalized error is computed as eᵢ=G_{f}_{ᵢ}(\hat{K}ᵢ, nᵢ, Nᵥ)−G_{f}_{ᵢ}(Kᵢ, nᵢ, Nᵥ)=ŷᵢ−0.5. Thus, eᵢ is uniformly distributed in [−0.5, 0.5]. This error normalization process calibrates an error relative to the accuracy of the estimator used.

In an example, for selectivity (proportion) estimation, the density function of the estimate is a binomial distribution with parameters p=K/Nᵥ and n, that is,

$$Bin ( x , K / {N}_{v} , n ) = ( \begin{matrix}n \\ x\end{matrix} ) {( K / {N}_{v} )}^{x} {( 1 - ( K / {N}_{v} ) )}^{n - x}$$

The function returns the probability that exactly x rows in a random sample of n rows satisfy the residual predicate when the actual fraction of all rows (the population) satisfying the predicate is K/Nᵥ. For mapping purposes, the cumulative binomial distribution is,

$$CumBin ( x , K / {N}_{v} , n ) = {\sum }_{i = 0}^{x} Bin ( i , K / {N}_{v} , n )$$

Alternatively, the cumulative binomial distribution can be expressed in terms of the Incomplete Beta function, which is well known to those skilled in the art. The binomial distribution Bin(x, p, n) can also be approximated by a normal distribution Norm(x, np, np(1−p)) provided that np and n(1−p) are not too small (e.g., np≧10 and n(1−p)>10).

In another aspect, sample view estimation component 102 can employ the stream of normalized cardinality estimation errors for each sample view along with process control techniques to determine when a sample view needs to be refreshed. As long as a sample view is a statistically valid random sample of its underlying view, the normalized errors are uniformly distributed in [−0.5, 0.5]. Standard statistical process control techniques can be applied by sample view estimation component 102 to monitor whether the quality of the estimates computed from the sample are still under control, that is, still within statistically acceptable bounds or thresholds. The thresholds can be defined by the system or a user. When the normalized cardinality estimation errors for a sample view are not within statistically acceptable bounds, sample view estimation component 102 can initiate producing a refreshed version of the sample view.

For example, instead of monitoring the normalized cardinality estimation errors eᵢ directly, variable zᵢ=2|eᵢ| can be monitored. The absolute value prevents negative and positive errors from cancelling each outer out. The variable |eᵢ| is uniformly distributed in [0, 0.5] and multiplying it by two produces a variable that is uniformly distributed in [0, 1]. To smooth out random variations, an exponentially weighted smoothed average (EWMA) of the monitored variable zᵢ can be computed. When error observation zᵢ arrives, the average is updated as follows,

E_{EWMA}:=α*zᵢ+(1−α)*E_{EWMA}.

The constant α is typically small, in the range of 0.05 or less. The higher the value, the more sensitive the average is to changes in the underlying data.

The sample view estimation component 102 triggers corrective action when the exponentially smoothed average drifts outside of an a priori defined control interval. The interval can be one-sided or two-sided depending on the process control technique. The control bounds are set so that the probability of remaining within the control interval is high, for example, in the order 0.99999 to 0.999999, as long as the process is statistically stable. A one-sided interval can be used to guard against large errors.

In this example, E_{EWMA} has a normal distribution with expected value 0.5 and standard deviation,

σ_{EWMA}:=2*\sqrt{(var_{uniform}*f_{EWMA})}=2*{square root over ((1/12*α/(2−α)))}.

The factor f_{EWMA}=α/(2−α) shows the dampening effect of the exponential smoothing. For example, with α=0.04, we have σ=0.082. In order to have the probability of remaining within the control interval be 0.99999, the control bound is set to 0.5+4.265*0.082=0.85.

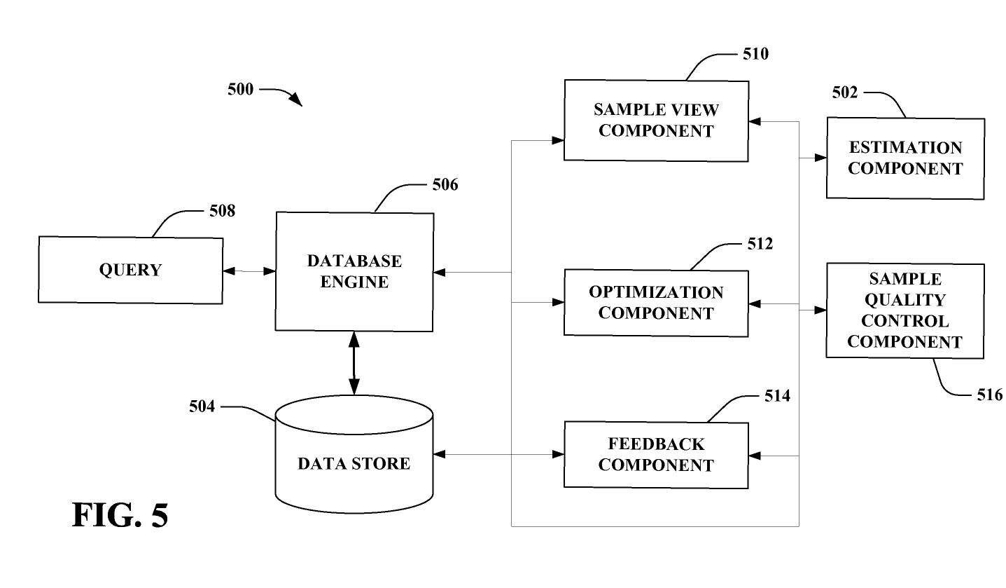

Turning to FIG. 5, there is illustrated a general block diagram system 500 employing random sampling and materialized views to estimate cardinality. System 500 includes sample view component 510 that maintains random samples of data output from view expressions when evaluated against data store 504 by database engine 506 to produce sample views. System 500 also includes an estimation component 502 that produces a cardinality estimate for query 508 or subexpressions thereof, an optimization component 512 that produces an optimized execution plan for query 508, a feedback component 514 that feeds back actual cardinalities when query 508 executes, and a sample quality control component 516 that controls when the sample view is refreshed. In one aspect, sample view component 510 creates sample views that contain simple random samples, for example, created by Bernoulli sampling in order to be able to apply a large class of estimators. When the view expression is evaluated, each output row is randomly selected for the sample with a specified probability. Hence, the actual percentage of rows in the sample may be slightly different than specified. The total number of rows in the view and number of rows in the sample view are recorded in a catalog maintained by the database system.

If the entire sample view is scanned, then an example probe query that can be constructed by estimation component 502 is the following:

SELECT COUNT(*) AS n_p FROM <view name> WHERE <pred>

Where <pred> is the placeholder for the residual predicate returned by view matching, <view name> is the name of the sample view, and n_p is the number of rows that satisfy the residual predicate. The sample size Nₛ is available in the catalog so the estimate can be computed as [symbol] =n_p/Nₛ.

Executing a probe query during query optimization increases the optimization time. The overhead can be reduced greatly by using sequential sampling. In sequential sampling only as many rows of the sample as is needed to compute a sufficiently accurate estimate are processed. In many cases, only a small subset of the rows is needed to reach the desired accuracy.

Optionally, sample view component 510 can assign a random identifier to each randomly selected output row of the view expression. The random identifier can be any appropriate value, such as a number, character(s), or symbol(s). For example, the internal representation of a sample view can contain an additional column _{—}_RAND of type integer. This column holds a random value drawn from a uniform distribution in the range [0; MAXRAND].

This makes it possible to apply sequential sampling on the sample view <svname>. Rows containing the same _{—}_RAND value are clustered together. If a sequential scan of the sample is terminated at the end of a cluster, the set of rows scanned is a statistically valid, simple random sample. However, this cannot be guaranteed if the scan is terminated within a cluster. Within a cluster the rows are sorted on <keycols> and the ordering may be correlated with selectivity. For example, rows early in the cluster may be more likely to satisfy the query predicate than rows later in the cluster.

Probe queries can be constructed by the estimation component 502 that evaluate a stopping condition at every break in the random identifier, _{—}_RAND column, and terminates the scan as soon as the condition is satisfied. One example of a stopping condition is whether the standard error of the cardinality estimate is within a specified range. In addition, two additional stopping conditions can be: ensuring that an estimate (possibly the latest computed cardinality estimate, or one based upon a default algorithm/function or pre-defined value) is returned when the whole sample has been scanned (even if the desired accuracy has not been reached); and ensure that the estimate is based on a minimal set of evidence. The minimal set of evidence can be based upon a predefined minimum number of rows that is numerically defined or defined by an algorithm/function. For both additional stopping conditions, the algorithm/function can be based upon factors associated with the query, the size of the sample, the required accuracy, user definition, or any other appropriate factors.

Evaluating complex stopping conditions very frequently can be expensive. To overcome this, values for the random identifier can be generated by the sample view component 510 from a small set of values and the probe queries only test the stopping condition once for each cluster of rows with the same random identifier value. For example, generating values in the range [1,100] means that the stopping condition is evaluated at most 100 times. Additionally, execution plans for probe queries can be modified to not contain any blocking operators (such as a sort), that is, operators that consume the whole input before producing output tuples.

Estimation component 512 can estimate the cardinality for query 508 or subexpressions thereof by employing one or more sample views and their respective probe queries. Where a sample view and/or probe query does not exist for a query expression or query subexpression, a sample view and/or probe query could be created as described above. Where cardinality estimates for multiple query subexpressions of query 508 are produced, a cardinality estimate for query 508 is produced by combining the cardinality estimates for the query subexpressions using any appropriate algorithm.

In one example, estimation component 512 estimates the cardinality for a query 508 or a subexpression thereof without aggregation as follows. A query expression E=σₚ_{_{q}}(T₁× . . . Tₙ) matches a (sample) view defined by V=σₚ_{ᵥ}(T₁× . . . Tₙ). if and only if p_{q} [symbol] pᵥ, that is, every row that satisfies the query predicate p_{q} also satisfies the view predicate pᵥ. If this is the case, the view matching procedure returns a residual predicate pᵣ with the property that p_{q}=pᵣ [symbol] pᵥ. If the view were fully materialized, query expression E could be computed from the view by the equivalent substitute expression E=σₚ_{ᵣ}V. This is not possible of course when the view contains only a sample but it can still be used for cardinality estimation. The sample view is used by estimation component 502 to estimate the cardinality of the expression σₚ_{ᵣ}V, which is an estimate of the cardinality of the original query expression σₚ_{_{q}}(T₁× . . . Tₙ).

Provided the view outputs all columns referenced in pᵣ, the probe query σₚ_{ᵣ}V can be run against the whole sample or any random subset thereof. If the probe query is run on a subset containing nₛ rows (nₛ≦Nₛ where Nₛ is the total number of rows in the sample view) and nₚ rows satisfy the residual predicate pᵣ, then an estimate of the selectivity of predicate pᵣ is [symbol] =nₚ/nₛ with an estimate of the standard error of [symbol] =\sqrt{ [symbol](1− [symbol] /nₛ)}. The cardinality of E can then be estimated as Card(E)= [symbol] Nᵥ, where Nᵥ is the total number of rows output from the view expression, with an estimated standard error of [symbol] = [symbol] Nᵥ.

If sequential sampling is employed, a more complex probe query is needed because the query must return both the number of rows scanned and the number of rows satisfying the predicate, use a sequential scan, and terminate as soon as the stopping condition has been reached.

The stopping condition, for example, can require that a certain minimum number of rows be read to have enough evidence. Once this number has been reached, scanning stops as soon as one of the following three example criteria is satisfied.
1. Relative Error: the 95% confidence interval is less than 10% of the point estimate.
2. Absolute Error: the estimate number of qualifying rows (in the real data set) is 10 or less with 90% confidence.
3. End of sample: the end of the sample is reached.

The stopping condition is evaluated only after combining sample rows that have the same _{—}_RAND value. The step-wise option causes the grouping operator to output its running results. The final top operator shuts down the query as soon as an estimate with acceptable accuracy is available.

In another example, estimation component 502 estimates the cardinality for query 508 or subexpression thereof with aggregation as follows. Consider a query expression E=γ_{G}^{A}σₚ_{_{q}}(T₁× . . . Tₙ) and a (sample) view defined by V=σₚ_{ᵥ}(T₁× . . . Tₙ). The notation γ_{G}^{A} specifies grouping with grouping expressions G and aggregation functions A. If the view matches, both further selection and further aggregation may be needed. View matching returns, in essence, the operators Y G σ_{G}^{A}σₚ_{ᵣ}. If the view were fully materialized, the query expression E could be computed from the view by the expression E=γ_{G}^{A}σₚ_{ᵣ}V. We use the sample to estimate the cardinality of the expression γ_{G}^{A}σₚ_{ᵣ}V, which also is an estimate of the cardinality of the original query expression.

Estimating the cardinality of γ_{G}^{A}σₚ_{ᵣ}V is the same as estimating the number of distinct values occurring in the result of π_{G}σₚ_{ᵣ}V. This is a statistical estimation problem, originally formulated as estimating the number of species in a population, and many different estimators have been utilized to address this problem. Three estimators have shown themselves to be more robust in experimentation: Chao's estimator, Shlosser's estimator, and the Poisson estimator. However, any estimator may be employed that is appropriate to the query and data being evaluated. A probe query can be employed that returns data needed by a variety of operators, allowing for the freedom to decide on an appropriate estimator or combination of estimators. Virtually all distinct-value estimators take as input value pairs consisting of (group size, number of groups of that size) computed from the sample. The probe query can return this information in a single tuple in order to support sequential sampling and terminate as soon as a stopping condition is met.

In the same way as for non-aggregation, stopping conditions for distinct-value estimation can be tied to the estimate's confidence interval. However, the calculations required to compute confidence intervals for general distinct-value estimators like Shlosser's estimator or jackknife-style estimators can be complex. In one example, a stopping condition that combines two factors is employed.
1. Confidence interval of Poisson estimator: As long as the sample is a small fraction of the population, the Poisson estimator generally provides a stable estimate and its confidence intervals are relatively easy to compute. Hence, our first stopping condition is that the 95% confidence interval of the Poisson estimator is less than 10% of its point estimate.
2. Distance between Chao and Shlosser estimator: The Chao estimator is a lower-bound estimator while the Shlosser estimator tends to overestimate the actual value. For larger sampling fractions, scanning stops when the (relative or absolute) difference between these two estimates becomes less than a target value.

Estimation component 502 utilizes the outputted tuple that satisfied the stopping condition to provide a cardinality estimate for query 508 when executed. Optimization component 512 employs the cardinality estimate in creating an optimized execution plan for the query 508.

In order to produce accurate cardinality estimates, a sample view must contain a statistically valid random sample of the results of the view expression. As the data in the underlying database tables changes, the statistical validity of the sample view must be maintained. In one aspect, the sample view is maintained by sample view component 510 in the same manner as regular materialized views, which are maintained incrementally. However, in some cases this approach can significantly increase utilization of system resources, as in the following cases:
1. When the view consists of multiple joins.
2. Incremental view maintenance is performed as part of the update transaction. The presence of sample views would then impact overall system load, even during peak times.

In another aspect, the sample view can be fully refreshed by only when required. Feedback from running queries provided by feedback component 514 can be used by sample quality control component 516 to check whether cardinality estimates computed from the sample view are still within statistical error bounds. Maintenance of the sample view is then deferred by sample quality control component 516 as long as the sample view statistically still represents the underlying data. Feedback component 514 can provide feedback to sample quality control component 516 of the actual cardinality that results each time query 508 is executed. The actual cardinalities can be linked/stored by feedback component 516 with the corresponding cardinality estimate for query 508. In an example, a sample view may have many different queries 508 returning feedback, some with low selectivity and some with high selectivity. Cardinality estimation errors from different queries 508 cannot be compared directly without first normalizing them, that is, converting them to a common scale. In this way, sample quality control component 516 employs normalized cardinality estimation errors. Sample quality control component 516 can apply standard statistical process control techniques to the stream of normalized errors to detect when the errors are no longer within statistical bounds and trigger a refresh of the sample view by sample view component 510.

In one example, the cardinality of some subexpressions Eᵢ, where i is the index of the subexpression, of query 508 may be estimated from a matching sample view. Some, not necessarily all, of those subexpressions Eᵢ may be present in the final execution plan. When a cardinality estimate for a subexpression Eᵢ is computed from a sample view, an InfoPack structure is associated with the subexpression Eᵢ and all expressions equivalent to Eᵢ by feedback component 514. If Eᵢ or any expression equivalent to Eᵢ appears in the final query execution plan, InfoPack is associated with the operator in the execution plan that corresponds to the root of Eᵢ. During execution, the operator counts the number of tuples the operator outputs and, provided that it has a valid count at the end, uses the information in the InfoPack to report back the count for the appropriate sample view to the feedback component 514. In an example, the InfoPack structure contains the following fields:
1. an identifier for the sample view used to compute the cardinality estimate
2. a version number of the sample view used
3. a flag indicating the type of estimator used
4. the estimated number of rows that will be produced by the operator, K
5. the actual number of rows produced by the operator, K, (filled in after execution)
6. the number of rows from the sample read by the probe query, n

If the operator has a valid row count when execution finishes, the actual cardinality is filled in by feedback component 514 and the InfoPack is passed to sample quality control component 516. In one example, a row count is not valid unless the operator has seen the end of input, which it may not do if, for instance, the query is terminated early by a user or by a Top operator.

In an aspect, sample quality control component 516 normalizes the feedback received for each sample view. Alternatively, this could also be done by the feedback component 514. Let S denote a random sample of size n drawn from the result of view V (population) with Nᵥ rows (Nᵥ>>n). The cardinality estimate \hat{K} is a function of S, that is, \hat{K}=fₑ(S) where fₑ is the estimator function. \hat{K} is a stochastic variable with a well-defined probability density function (pdf) that depends on the estimator fₑ and the sampling scheme. An example sampling scheme is to draw simple random samples of size n from a population of size Nᵥ. Denote the probability density function of \hat{K} for this scenario by P(\hat{K}=x)=g_{f}_{ₑ}(x, n, Nᵥ) and the cumulative density function (cdf) by P(\hat{K}≦x)=G_{f}_{ₑ}(x, n, Nᵥ).

As queries execute, sample quality control component 516 receives a stream of actual cardinalities corresponding to estimates computed from view V for each query 1 . . . i, i being an integer. In one aspect, the stream received denoted by R₁, R₂, . . . Rᵢ is not a simple value but a tuple consisting of (Kᵢ, \hat{K}ᵢ, fᵢ, nᵢ) where Kᵢ is the actual cardinality, Kᵢ is the estimated cardinality, f indicates which estimator was used, and nᵢ is the sample size used when computing the cardinality estimate.

In the case where the estimation errors are based upon the same estimator and same sample size, the errors can be computed as \hat{K}ᵢ−Kᵢ. However, when the estimates are based on different estimators and different sample sizes, the errors from each query must be normalized by sample quality control component 516. In this case, the errors are converted to a common scale by mapping \hat{K}ᵢ through the estimator's fᵢ cumulative density function, that is, ŷᵢ=G_{f}_{ᵢ}(\hat{K}ᵢ, nᵢ, Nᵥ). Because the mapping is through the estimator's cdf, ŷᵢ is, by definition, uniformly distributed in with expected value E(ŷᵢ)=0.5 and variance S²(ŷᵢ)=1/12. If the estimator is unbiased, then G_{f}_{ᵢ}(Kᵢ, nᵢ, Nᵥ)=0.5. The normalized error is computed as Eᵢ=G_{f}_{ᵢ}(\hat{K}ᵢ, nᵢ, Nᵥ)−G_{f}_{ᵢ}(Kᵢ, nᵢ, Nᵥ)=ŷᵢ−0.5. Thus, eᵢ is uniformly distributed in [−0.5, 0.5]. This error normalization process calibrates an error relative to the accuracy of the estimator used.

Sample quality control component 516 can employ the stream of normalized cardinality estimation errors for each sample view along with process control techniques to determine when a sample view needs to be refreshed. As long as a sample view is a statistically valid random sample of its underlying view, the normalized errors are uniformly distributed in [−0.5, 0.5]. Standard statistical process control techniques can be applied by sample quality control component 516 to monitor whether the quality of the estimates computed from the sample view are still under control, that is, still within statistically acceptable bounds. When the normalized cardinality estimation errors for a sample view are not within statistically acceptable bounds, sample quality control component 516 can trigger sample view component 510 to produce a refreshed version of the sample view.

Sample views can be employed beyond cardinality estimation. Many times large quantities of data must be analyzed in order to understand certain aspects of the data using data analysis operations that are not easily implemented via database query languages. Data analysis operations can involve algorithms, functions, queries, or any combination thereof, performed against the data For example, businesses collect sales and demographic data in order to develop product, sales, and marketing strategies. In another example, a government collects large amounts data on people in their country and visitors entering their country in order to detect possible threats. Yet another example, are scientists who collect large amounts of data, such as genetic information, which must be analyzed to identify potential areas for further research or grant proposals. The resources and time required to perform the data analysis on the large amount of data can be significant. Employing sample views, data analysis can be performed on a statistically significant random sample of the data, thereby providing estimated data analysis results that meet a statistical accuracy requirement.

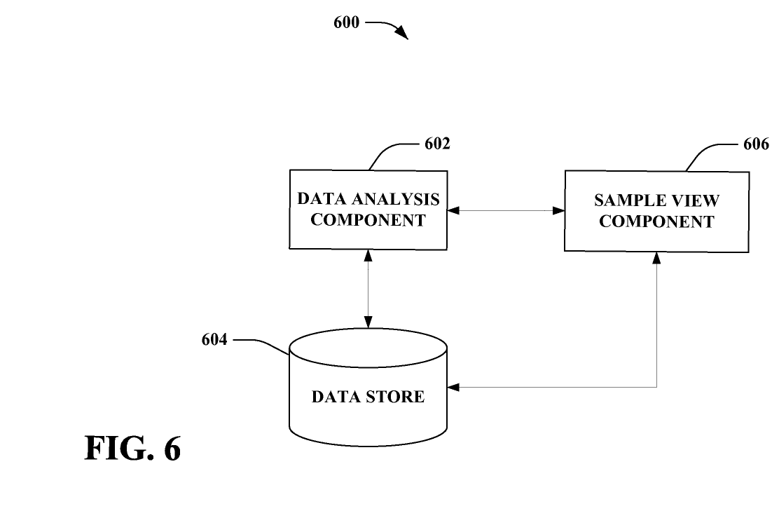

Referring to FIG. 6, there is illustrated a general block diagram system 600 employing random sampling and materialized views to estimate the results of a data analysis operation. System 600 includes sample view component 606 that takes random samples of data output from a view expression related to a data analysis operation against data store 604 by data analysis component 602 to produce a sample view.

Data analysis component 602 can execute the data analysis operation or approximation of the data analysis operation against the whole sample or any random subset thereof to estimate the results of the data operation on the entire data set represented by the sample view.

In order to produce accurate estimates of the results of the data analysis operation, a sample view must contain a statistically valid random sample of the results of the view expression. As the data in the underlying database tables changes, the statistical validity of the sample view must be maintained. The sample view is maintained by sample view component 606 incrementally or when required based upon statistical process control techniques on feedback from data analysis component 602.

In view of the exemplary systems shown and described supra, methodologies that may be implemented in accordance with the disclosed subject matter will be better appreciated with reference to the following flow charts. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers.

The claimed subject matter can be described in the general context of computer-executable instructions, such as program modules, executed by one or more components. Generally, program modules can include routines, programs, objects, data structures, etc. that perform particular tasks or implement particular abstract data types. Typically the functionality of the program modules may be combined and/or distributed as desired in various aspects.

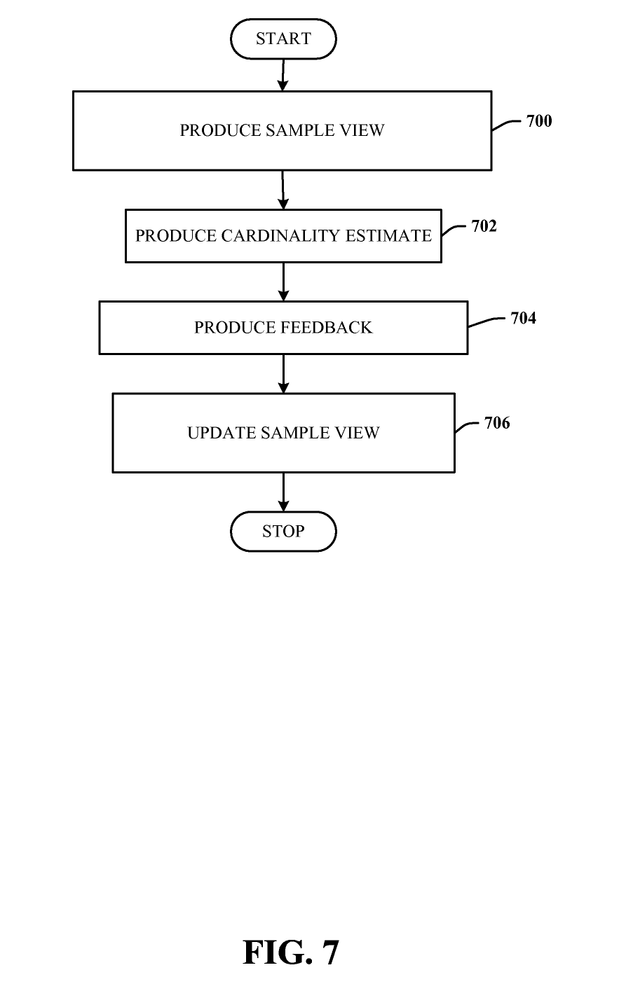

Referring now to FIG. 7, there is illustrated a flow chart of one methodology for employing random sampling and materialized views to estimate cardinality. At step 700 random samples of data output from a view expression related to a query against a data store are selected to produce a sample view. Multiple sample views may be created for subexpressions of a single query. At step 702 one or more probe queries are created and executed against the sample view(s) to produce a cardinality estimate(s) for one or more queries. At step 704, feedback identifying actual cardinalities of execution of each query are produced and associated with their respective cardinality estimate(s) for each query. At 706, the feedback is employed with statistical process control techniques to trigger an update of one or more sample views.

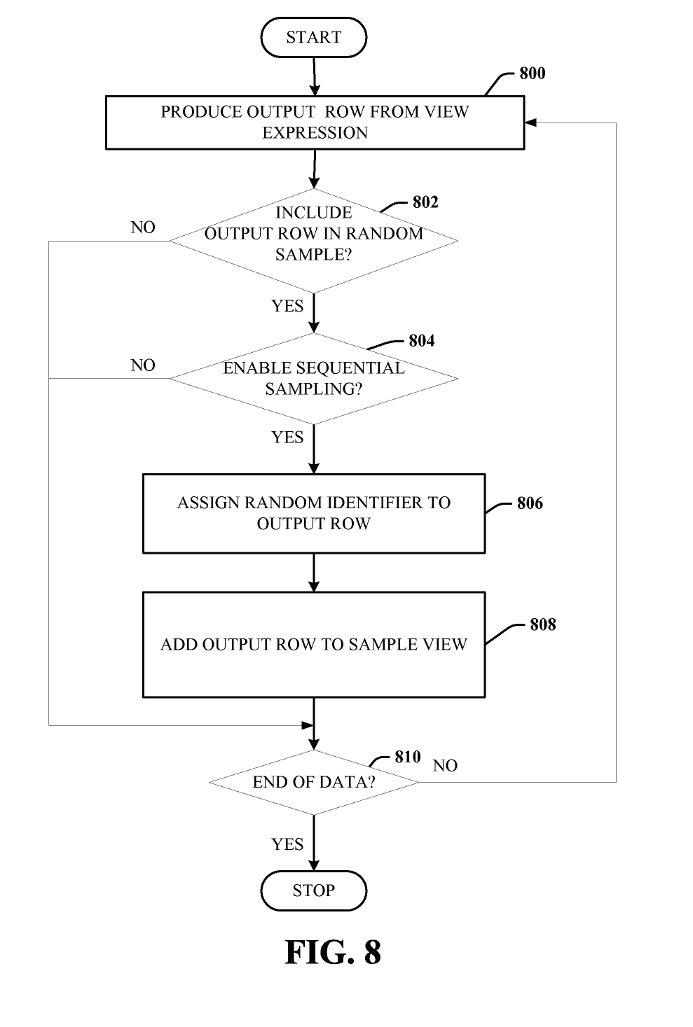

Referring to FIG. 8, there is illustrated a flow chart of one methodology for creating a sample view. In one aspect, sample views contain simple random samples, for example, created by Bernoulli sampling in order to be able to apply a large class of estimators. At 800, the view expression is evaluated, producing a sequence of rows, outputting them one at a time. At 802, the output row may be randomly selected for the sample view. If the output row is selected, the method proceeds to 804. If not selected, the method proceeds to 810.

Optionally, when sequential sampling is to be enabled, a random identifier can be assigned to each randomly selected output row of the view expression. At 804, it is determined if sequential sampling is to be enabled. If sequential sampling is to be enabled the method proceeds to 806, otherwise the method proceeds to 810. At 806, a random identifier is assigned to the output row and the method proceeds to 808. At 808, the output row is added to the sample view and the method proceeds to 810. At 810, a determination is made if the end of data for evaluating the view expression has been reached. If the end has been reached, the method stops. If there is more data, then the method proceeds to 800.

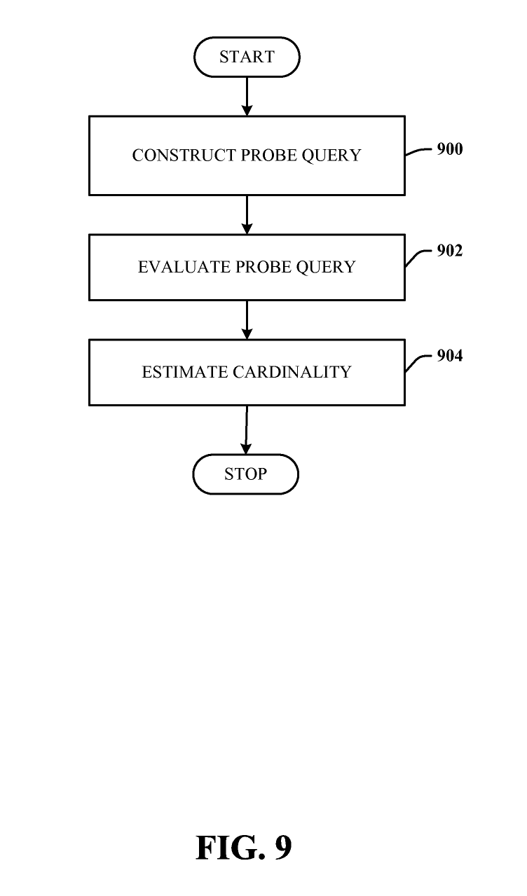

FIG. 9 illustrates a flow chart of one methodology for employing probe queries with sample views to estimate the cardinality of a query.

At 900, a probe query are constructed based upon matching of a query expression E with a sample view V. In one example, a probe query may be constructed to evaluate a stopping condition at every break in a random identifier associated with each row of data and terminates the query as soon as the condition is satisfied.

At 902, the probe query is evaluated by the database engine in the same manner as a regular query submitted by a user. The probe query returns one row that contains quantities computed from the sample that are needed to compute a cardinality estimate. At 904, the cardinality for the query expression E is estimated based upon result produced by the probe query.

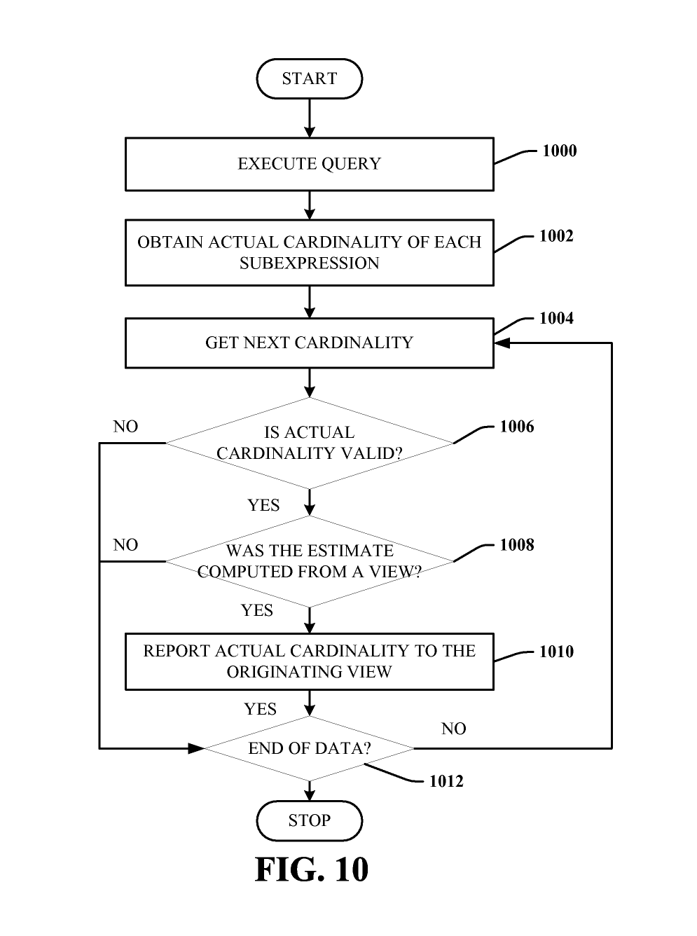

FIG. 10 illustrates a flow chart of one methodology for providing feedback on actual cardinalities for executed queries. At 1000, a query is executed. At 1002, the actual cardinalities, for all its subexressions, that result from executing the query are obtained. In one example, the cardinality of some of the n subexpressions Eᵢ, i=1, 2 . . . n, of the query may be estimated from matching sample views. Some, not necessarily all, of those subexpressions Eᵢ may be present in the final execution plan. At 1004 the next actual cardinality, among the ones obtained in 1002, is examined. At 1006 it is determined whether the actual cardinality is valid, that is, whether execution of the subexpression completed normally. If the cardinality is not valid, the process continues to 1012. If it is valid, the process continues to 1008 where it is determined whether the estimated cardinality was computed from a sample view and, if so, which sample view. If the estimate was not computed from a sample view, the process continues to 1012. If it was computed from a view, the actual cardinality and information related to the estimate are reported back to the view. If there are no more actual cardinalities to process, the process terminates.

In one example, the information associated with an estimate may contain the following fields, here referred to as an Infopack:
1. an identifier for the sample view used to compute the cardinality estimate
2. a version number of the sample view used
3. a flag indicating the type of estimator used
4. the estimated number of rows that will be produced by the operator, \hat{K}
5. the actual number of rows produced by the operator, K, (filled in after execution)
6. the number of rows from the sample read by the probe query, n

If the operator has a valid row count when execution finishes, the actual cardinality is added into the InfoPack. In one example, a row count is not valid unless the operator has seen the end of input, which it may not do if, for instance, the query is terminated early by a user or by a Top operator.

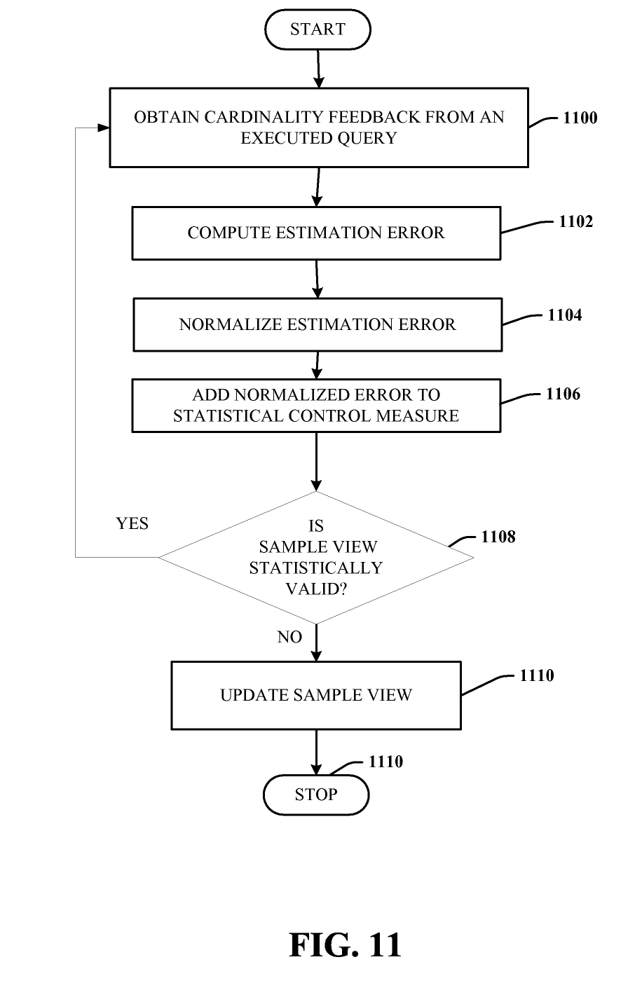

FIG. 11 illustrates a flow chart of one methodology for employing process control techniques to initiate an update to a sample view. Feedback from running queries can be used to check whether cardinality estimates computed from the sample view are still within statistical error bounds. Maintenance of the sample view can then be deferred as long as the sample view statistically still represents the underlying data. At 1100, feedback of the actual cardinality that results each time a query is executed is obtained. The feedback links the actual cardinality with the corresponding cardinality estimate for the query and sample view.

Let S denote a random sample of size n drawn from the result of view V (population) with Nᵥ rows (Nᵥ [symbol] n). The cardinality estimate \hat{K} is a function of S, that is, \hat{K}=fₑ(S) where fₑ is the estimator function. \hat{K} is a stochastic variable with a well-defined probability density function (pdf) that depends on the estimator fₑ and the sampling scheme. An example sampling scheme random samples of size n that are drawn from a population of size Nᵥ. Denote the probability density function of \hat{K} for this scenario by P(\hat{K}=x)=g_{f}_{ₑ}(x, n, Nᵥ) and the cumulative density function (cdf) by P(\hat{K}≦x)=G_{f}_{ₑ}(x,n, N).

As queries execute, stream of actual cardinalities corresponding to estimates computed from view V for each query 1 . . . i, i being an integer, are obtained. In one aspect, the stream received denoted by R₁, R₂, . . . Rᵢ is not a simple value but a tuple consisting of (Kᵢ, \hat{K}ᵢ, fᵢ, nᵢ) where Kᵢ is the actual cardinality, \hat{K}ᵢ is the estimated cardinality, fᵢ indicates which estimator was used, and nᵢ is the sample size used when computing the cardinality estimate.

At 1102, the cardinality estimation error is determined. In the case where the estimation errors are based upon the same estimator and same sample size, the errors can be computed as \hat{K}ᵢ−Kᵢ. However, when the estimates are based on different estimators and different sample sizes, the errors from each query must be normalized. At 1104, the cardinality estimation error is normalized. The error is converted to a common scale by mapping \hat{K}ᵢ through the estimator's fᵢ cumulative density function, that is, ŷᵢ=G_{f}_{ᵢ}(\hat{K}ᵢ, nᵢ, Nᵥ). Because the mapping is through the estimator's cdf, ŷᵢ is, by definition, uniformly distributed in [0, 1] with expected value E(ŷᵢ)=0.5 and variance S²(ŷᵢ)=1/12. If the estimator is unbiased, then G_{f}_{ᵢ}(Kᵢ, nᵢ, Nᵥ)=0.5. The normalized error is computed as eᵢ=G_{f}_{ᵢ}(\hat{K}ᵢ, nᵢ, Nᵥ)−G_{f}_{ᵢ}(Kᵢ, nᵢ, Nᵥ)=ŷᵢ−0.5. Thus, eᵢ is uniformly distributed in [−0.5, 0.5]. This error normalization process calibrates an error relative to the accuracy of the estimator used.

At 1106, the normalized error is added to the statistical control measure employed. At 1108, the updated value of the control measure is checked to determine if the sample view is still a statistically valid random sample of its underlying view. As long as a sample view is a statistically valid random sample of its underlying view, the normalized errors are uniformly distributed in [−0.5, 0.5]. Standard statistical process control techniques can be applied to monitor whether the quality of the estimates computed from the sample view are still within statistically acceptable bounds. If the sample view is statistically valid, the method proceeds to 1100. If the sample view is not statistically valid, the method proceeds to 1108. At 1108, the sample view is refreshed.

In an example, variable zᵢ=2|eᵢ| can be monitored instead of monitoring the normalized cardinality estimation errors eᵢ directly. The absolute value prevents negative and positive errors from cancelling each outer out. The variable |eᵢ| is uniformly distributed in [0, 0.5] and multiplying it by two produces a variable that is uniformly distributed in [0, 1]. To smooth out random variations, an exponentially weighted smoothed average (EWMA) of the monitored variable zᵢ can be used as the control measure. When error observation zᵢ arrives, the average is updated as follows,

E_{EWMA}:=α*zᵢ+(1−α)*E_{EWMA}.

The constant α is typically small, in the range of 0.05 or less. The higher the value, the more sensitive the average is to changes in the underlying data. The sample is updated when the exponentially smoothed average drifts outside of an a priori defined control interval. The interval can be one-sided or two-sided depending on the process control technique. The control bounds are set so that the probability of remaining within the control interval is high, for example, in the order 0.99999 to 0.999999, as long as the process is statistically stable. A one-sided interval can be used to guard against large errors.

The claimed subject matter can be implemented via object oriented programming techniques. For example, each component of the system can be an object in a software routine or a component within an object. Object oriented programming shifts the emphasis of software development away from function decomposition and towards the recognition of units of software called “objects” which encapsulate both data and functions. Object Oriented Programming (OOP) objects are software entities comprising data structures and operations on data. Together, these elements enable objects to model virtually any real-world entity in terms of its characteristics, represented by its data elements, and its behavior represented by its data manipulation functions. In this way, objects can model concrete things like people and computers, and they can model abstract concepts like numbers or geometrical concepts.

The benefit of object technology arises out of three basic principles: encapsulation, polymorphism and inheritance. Objects hide or encapsulate the internal structure of their data and the algorithms by which their functions work. Instead of exposing these implementation details, objects present interfaces that represent their abstractions cleanly with no extraneous information. Polymorphism takes encapsulation one-step further—the idea being many shapes, one interface. A software component can make a request of another component without knowing exactly what that component is. The component that receives the request interprets it and figures out according to its variables and data how to execute the request. The third principle is inheritance, which allows developers to reuse pre-existing design and code. This capability allows developers to avoid creating software from scratch. Rather, through inheritance, developers derive subclasses that inherit behaviors that the developer then customizes to meet particular needs.

In particular, an object includes, and is characterized by, a set of data (e.g., attributes) and a set of operations (e.g., methods), that can operate on the data. Generally, an object's data is ideally changed only through the operation of the object's methods. Methods in an object are invoked by passing a message to the object (e.g., message passing). The message specifies a method name and an argument list. When the object receives the message, code associated with the named method is executed with the formal parameters of the method bound to the corresponding values in the argument list. Methods and message passing in OOP are analogous to procedures and procedure calls in procedure-oriented software environments.

However, while procedures operate to modify and return passed parameters, methods operate to modify the internal state of the associated objects (by modifying the data contained therein). The combination of data and methods in objects is called encapsulation. Encapsulation provides for the state of an object to only be changed by well-defined methods associated with the object. When the behavior of an object is confined to such well-defined locations and interfaces, changes (e.g., code modifications) in the object will have minimal impact on the other objects and elements in the system.

Each object is an instance of some class. A class includes a set of data attributes plus a set of allowable operations (e.g., methods) on the data attributes. As mentioned above, OOP supports inheritance—a class (called a subclass) may be derived from another class (called a base class, parent class, etc.), where the subclass inherits the data attributes and methods of the base class. The subclass may specialize the base class by adding code which overrides the data and/or methods of the base class, or which adds new data attributes and methods. Thus, inheritance represents a mechanism by which abstractions are made increasingly concrete as subclasses are created for greater levels of specialization.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Artificial intelligence based systems (e.g., explicitly and/or implicitly trained classifiers) can be employed in connection with performing inference and/or probabilistic determinations and/or statistical-based determinations as in accordance with one or more aspects of the claimed subject matter as described hereinafter. As used herein, the term “inference,” “infer” or variations in form thereof refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, all or portions of the claimed subject matter may be implemented as a system, method, apparatus, or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

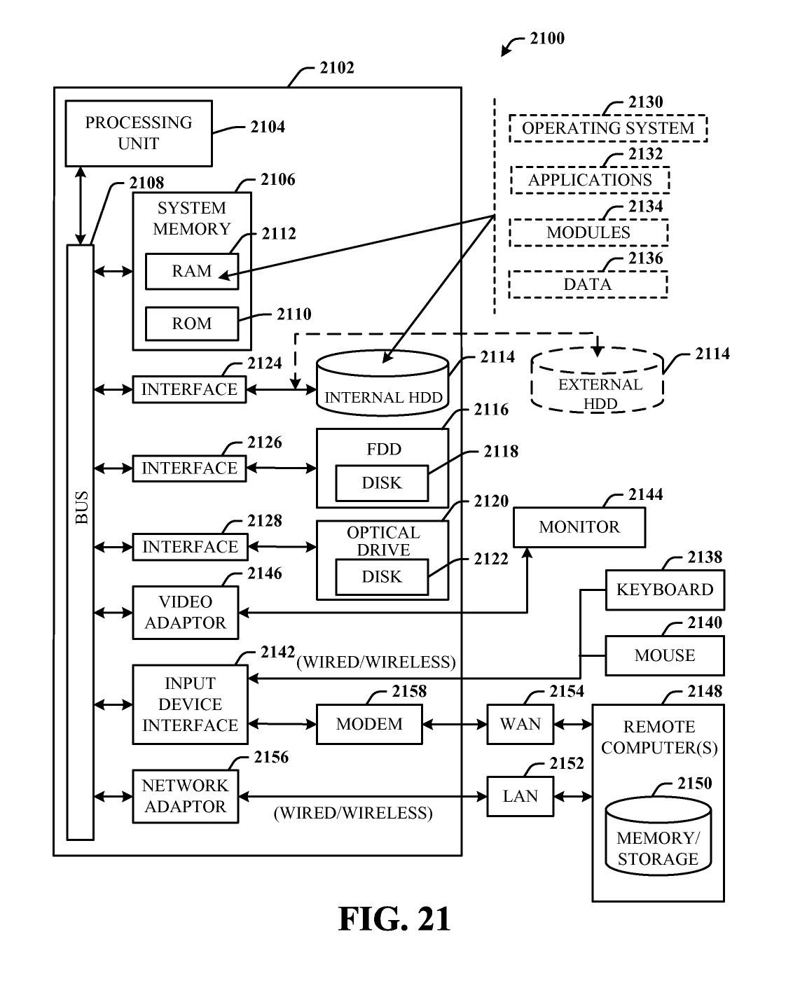

Referring now to FIG. 21, there is illustrated a block diagram of a computer operable to execute the disclosed system. In order to provide additional context for various aspects thereof, FIG. 21 and the following discussion are intended to provide a brief, general description of a suitable computing environment 2100 in which the various aspects of the claimed subject matter can be implemented. While the description above is in the general context of computer-executable instructions that may run on one or more computers, those skilled in the art will recognize that the subject matter as claimed also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 21, the exemplary environment 2100 for implementing various aspects includes a computer 2102, the computer 2102 including a processing unit 2104, a system memory 2106 and a system bus 2108. The system bus 2108 couples system components including, but not limited to, the system memory 2106 to the processing unit 2104. The processing unit 2104 can be any of various commercially available processors. Dual microprocessors and other multi-processor architectures may also be employed as the processing unit 2104.

The system bus 2108 can be any of several types of bus structure that may further interconnect to a memory bus (with or without a memory controller), a peripheral bus, and a local bus using any of a variety of commercially available bus architectures. The system memory 2106 includes read-only memory (ROM) 2110 and random access memory (RAM) 2112. A basic input/output system (BIOS) is stored in a non-volatile memory 2110 such as ROM, EPROM, EEPROM, which BIOS contains the basic routines that help to transfer information between elements within the computer 2102, such as during start-up. The RAM 2112 can also include a high-speed RAM such as static RAM for caching data.

The computer 2102 further includes an internal hard disk drive (HDD) 2114 (e.g., EIDE, SATA), which internal hard disk drive 2114 may also be configured for external use in a suitable chassis (not shown), a magnetic floppy disk drive (FDD) 2116, (e.g., to read from or write to a removable diskette 2118) and an optical disk drive 2120, (e.g., reading a CD-ROM disk 2122 or, to read from or write to other high capacity optical media such as the DVD). The hard disk drive 2114, magnetic disk drive 2116 and optical disk drive 2120 can be connected to the system bus 2108 by a hard disk drive interface 2124, a magnetic disk drive interface 2126 and an optical drive interface 2128, respectively. The interface 2124 for external drive implementations includes at least one or both of Universal Serial Bus (USB) and IEEE 1394 interface technologies. Other external drive connection technologies are within contemplation of the claimed subject matter.

The drives and their associated computer-readable media provide nonvolatile storage of data, data structures, computer-executable instructions, and so forth. For the computer 2102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed and claimed subject matter.

A number of program modules can be stored in the drives and RAM 2112, including an operating system 2130, one or more application programs 2132, other program modules 2134 and program data 2136. All or portions of the operating system, applications, modules, and/or data can also be cached in the RAM 2112. It is to be appreciated that the claimed subject matter can be implemented with various commercially available operating systems or combinations of operating systems.

A user can enter commands and information into the computer 2102 through one or more wired/wireless input devices, e.g., a keyboard 2138 and a pointing device, such as a mouse 2140. Other input devices (not shown) may include a microphone, an IR remote control, a joystick, a game pad, a stylus pen, touch screen, or the like. These and other input devices are often connected to the processing unit 2104 through an input device interface 2142 that is coupled to the system bus 2108, but can be connected by other interfaces, such as a parallel port, an IEEE 1394 serial port, a game port, a USB port, an IR interface, etc.

A monitor 2144 or other type of display device is also connected to the system bus 2108 via an interface, such as a video adapter 2146. In addition to the monitor 2144, a computer typically includes other peripheral output devices (not shown), such as speakers, printers, etc.

The computer 2102 may operate in a networked environment using logical connections via wired and/or wireless communications to one or more remote computers, such as a remote computer(s) 2148. The remote computer(s) 2148 can be a workstation, a server computer, a router, a personal computer, portable computer, microprocessor-based entertainment appliance, a peer device or other common network node, and typically includes many or all of the elements described relative to the computer 2102, although, for purposes of brevity, only a memory/storage device 2150 is illustrated. The logical connections depicted include wired/wireless connectivity to a local area network (LAN) 2152 and/or larger networks, e.g., a wide area network (WAN) 2154. Such LAN and WAN networking environments are commonplace in offices and companies, and facilitate enterprise-wide computer networks, such as intranets, all of which may connect to a global communications network, e.g., the Internet.

When used in a LAN networking environment, the computer 2102 is connected to the local network 2152 through a wired and/or wireless communication network interface or adapter 2156. The adaptor 2156 may facilitate wired or wireless communication to the LAN 2152, which may also include a wireless access point disposed thereon for communicating with the wireless adaptor 2156.

When used in a WAN networking environment, the computer 2102 can include a modem 2158, or is connected to a communications server on the WAN 2154, or has other means for establishing communications over the WAN 2154, such as by way of the Internet. The modem 2158, which can be internal or external and a wired or wireless device, is connected to the system bus 2108 via the serial port interface 2142. In a networked environment, program modules depicted relative to the computer 2102, or portions thereof, can be stored in the remote memory/storage device 2150. It will be appreciated that the network connections shown are exemplary and other means of establishing a communications link between the computers can be used.

The computer 2102 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+Mbps in the 2.4 GHz band. Products can contain more than one band (e.g., dual band), so the networks can provide real-world performance similar to the basic 10BaseT wired Ethernet networks used in many offices.

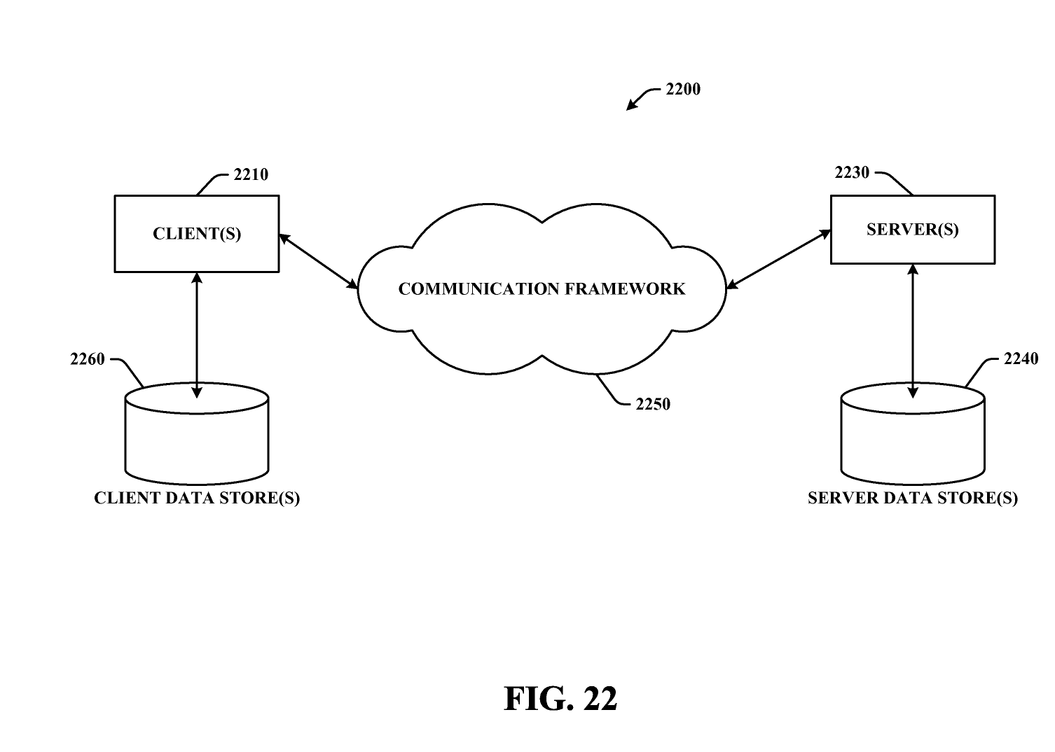

Referring now to FIG. 22, there is illustrated a schematic block diagram of an exemplary computing environment 2200 for processing the inference-based query completion architecture in accordance with another aspect. The system 2200 includes one or more client(s) 2202. The client(s) 2202 can be hardware and/or software (e.g., threads, processes, computing devices). The client(s) 2202 can house cookie(s) and/or associated contextual information by employing the claimed subject matter, for example.

The system 2200 also includes one or more server(s) 2204. The server(s) 2204 can also be hardware and/or software (e.g., threads, processes, computing devices). The servers 2204 can house threads to perform transformations by employing the claimed subject matter, for example. One possible communication between a client 2202 and a server 2204 can be in the form of a data packet adapted to be transmitted between two or more computer processes. The data packet may include a cookie and/or associated contextual information, for example. The system 2200 includes a communication framework 2206 (e.g., a global communication network such as the Internet) that can be employed to facilitate communications between the client(s) 2202 and the server(s) 2204.

Communications can be facilitated via a wired (including optical fiber) and/or wireless technology. The client(s) 2202 are operatively connected to one or more client data store(s) 2208 that can be employed to store information local to the client(s) 2202 (e.g., cookie(s) and/or associated contextual information). Similarly, the server(s) 2204 are operatively connected to one or more server data store(s) 2210 that can be employed to store information local to the servers 2204.

### Experimental Results

Throughout the discussion below, experimental results based on exemplary sets of data are presented to further support or illustrate various aspects of the subject application. It should be appreciated and understood that such experiments are not intended to limit the scope of the systems and methods described herein to particular scenarios, operating conditions or applications but are provided as examples. Moreover, the subject application can be employed with respect to any type of data set, on a remote and/or local server, storage facility, or on any computing device or network.

We use the following query against a 1GB TPC-H database to demonstrate the benefits of sample views and sequential sampling.

```
SELECT c_nationkey, count(*)
FROM lineitem, orders, customer
WHERE 1_receiptdate < DATEADD(day, 30, 1_shipdate)
    AND 1_commitdate < DATEADD(day, 30, 1_shipdate)
    AND 1_commitdate < DATEADD(day, 30, 1_receiptdate)
    AND 1_receiptdate > ’1996-01-01’
    AND 1_commitdate > ’1996-01-01’
    AND 1_shipdate > ’1996-01-01’
    AND 1_quantity > 25
    AND 1_orderkey = o_orderkey
    AND c_custkey = o_custkey
GROUP BY c_nationkey
```

The query contains a complex predicate on the lineitem table. Columns 1_receiptdate and 1_commitdate are heavily correlated but the regular cardinality estimation assumes that they are independent. It estimates that only 1,830 out of approximately 6 million lineitem rows satisfy the predicate, which underestimates the actual number of 903,791 rows by more than two orders of magnitude.

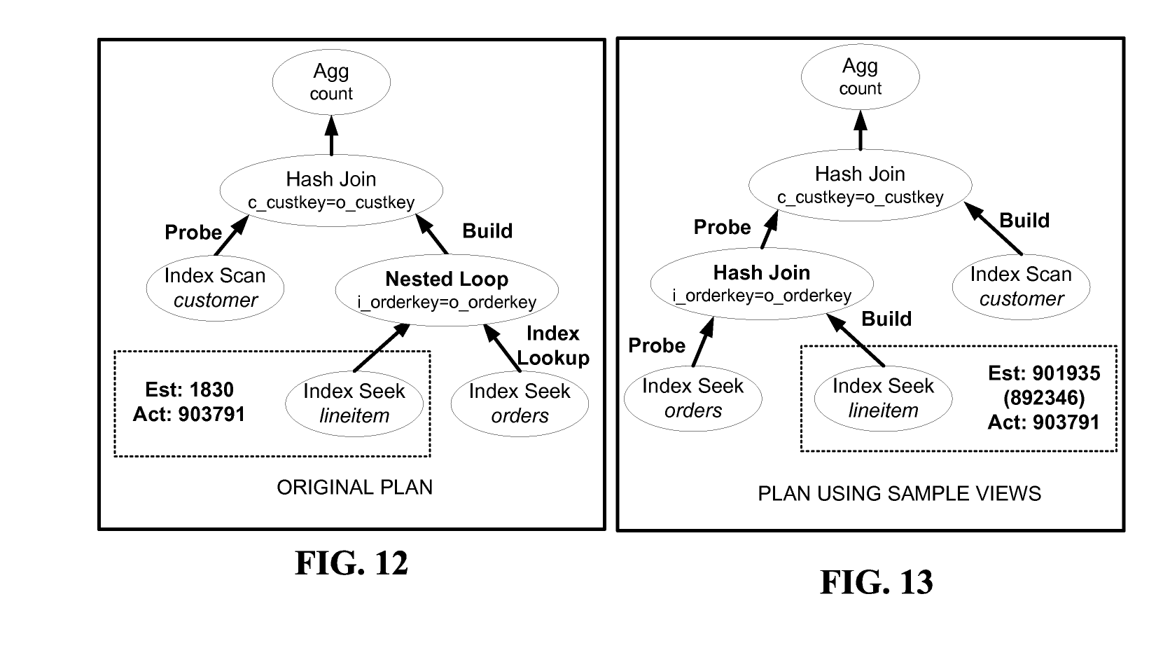

The query plan generated by the optimizer based on the incorrect estimate is shown in FIG. 12. The plan makes sense under the assumption that only a small number of lineitem rows qualify. The few rows are joined to orders by a nested-loop join. The result is still small, compared with customer, and thus used to build a hash table while the larger customer table probes the hash table. The join result is aggregated to obtain the final result. However, the actual number of qualifying lineitem rows is large, making the nested-loop join a very poor choice.

To improve cardinality estimation we created a sample view svlineitem containing a 1% sample of lineitem (59,538 rows). This sample view was used to estimate the number of qualifying lineitem rows, using both a full scan of the sample and sequential sampling. Table 1 summarizes the cardinality estimates obtained and the number of sample rows scanned.

TABLE 1
Estimated number of lineitem rows satisfying the predicate (actual
number is 903,791)

Using sample view

| | Original | Full sample | Sequential |
|---|---|---|---|
| Estimate | 1830 | 901,935 | 892,346 |
| Sampled rows | N/A | 59,538 | 5,974 |

The estimates computed from the sample view are highly accurate, no matter whether we do a full scan or use sequential sampling. Note that the sequential sampling stops after scanning only 5,974 rows, which is about one thousandth of the rows in the lineitem table.

With the more accurate cardinality estimates available, the optimizer produces a different plan, which is shown in FIG. 13. A hash join between lineitem and orders is used instead of a nested-loop join. Since the result is larger than the customer table, the customer table is used as the build input.

So far we have shown that using the sample view dramatically improves the accuracy of the estimate, which affects the choice of query plan. Table 2 summarizes the effects on optimization and execution times.

TABLE 2
Optimization and execution times

Using sample view

| | Original | Full | Sequential |
|---|---|---|---|
| Optimization (secs) | 0.095 | 0.153 | 0.120 |

| | | |
|---|---|---|
| Execution (secs) | 14.462 | 3.891 |

The revised plan achieves a 4-fold speedup in execution time. A full scan of the sample view increased the optimization time by about 50% but the overhead is negligible compared with savings in execution time. Sequential sampling cuts the optimization overhead in half without losing any benefit. The cost of sequential sampling does not necessarily grow with the sample view size because scanning stops as soon as the desired accuracy has been reached.

Experimentation with incrementally refreshing sample views showed that the overhead is simply too high, especially if the view consists of multiple joins. Even after applying a variety of tricks, overheads of 5-10% were still observed for updating a single view joining three tables.

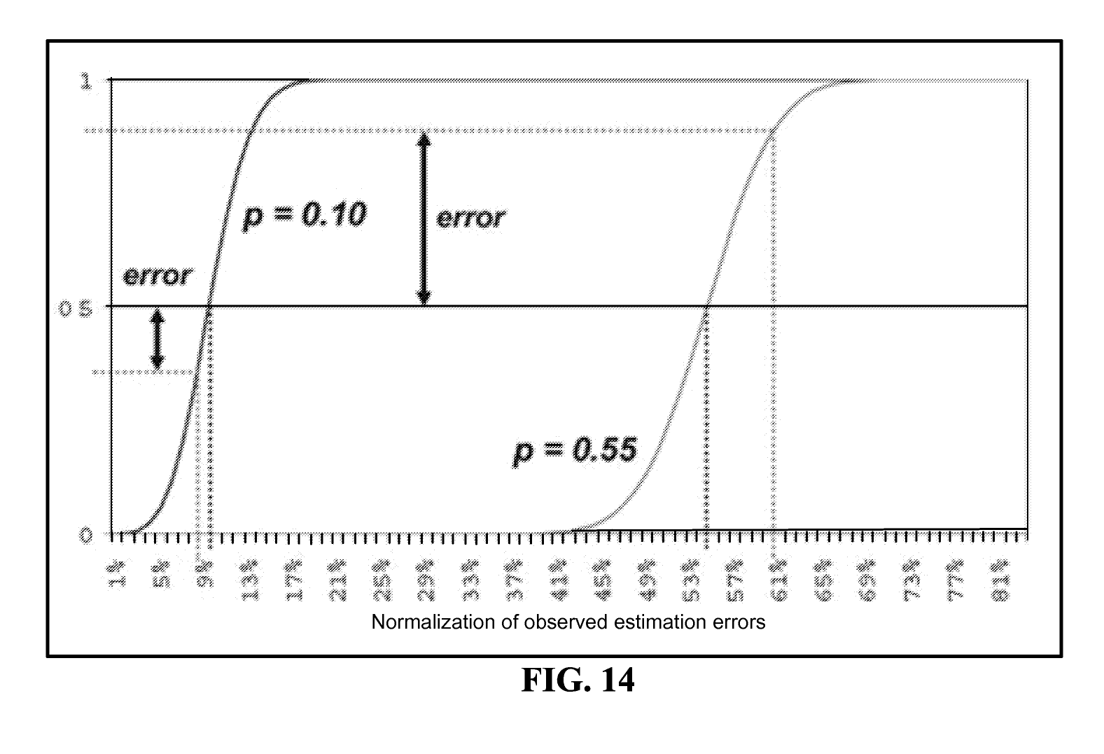

FIG. 14 illustrates the normalization process for two different predicates, one with selectivity 10% and one with selectivity 55%. An exact estimate (\hat{K}ᵢ=Kᵢ) would result in eᵢ=(0.5−0.5)=0. Overestimating the selectivity as 61% when the actual selectivity is 55%, yields a normalized error of eᵢ=(0.89−0.5)=0.39. Underestimating it as 9% when the actual rate is 10% produces a normalized error of eᵢ=(0.38−0.5)=−0.12.

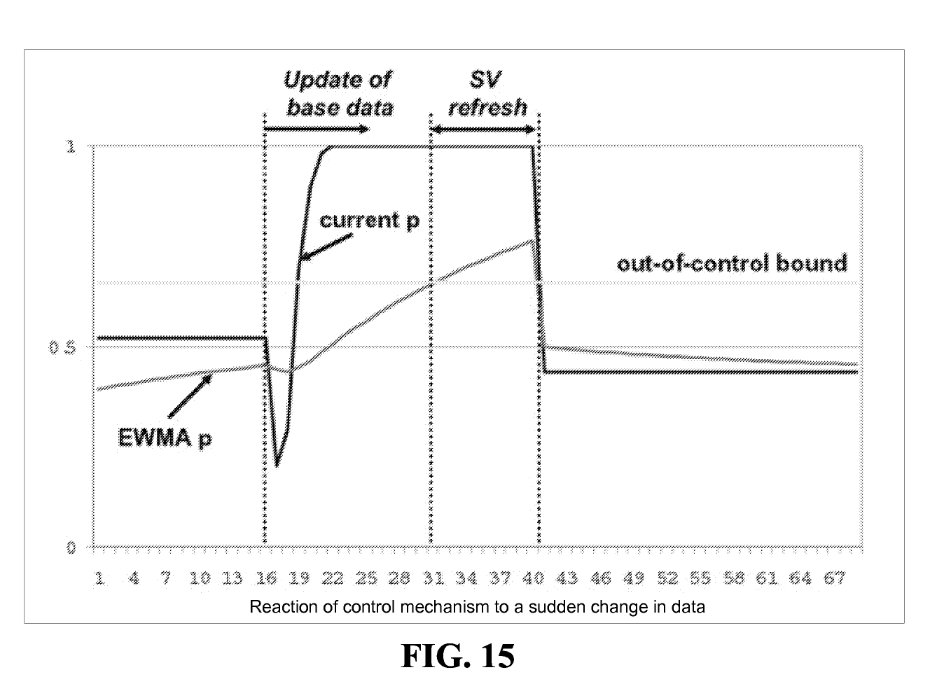

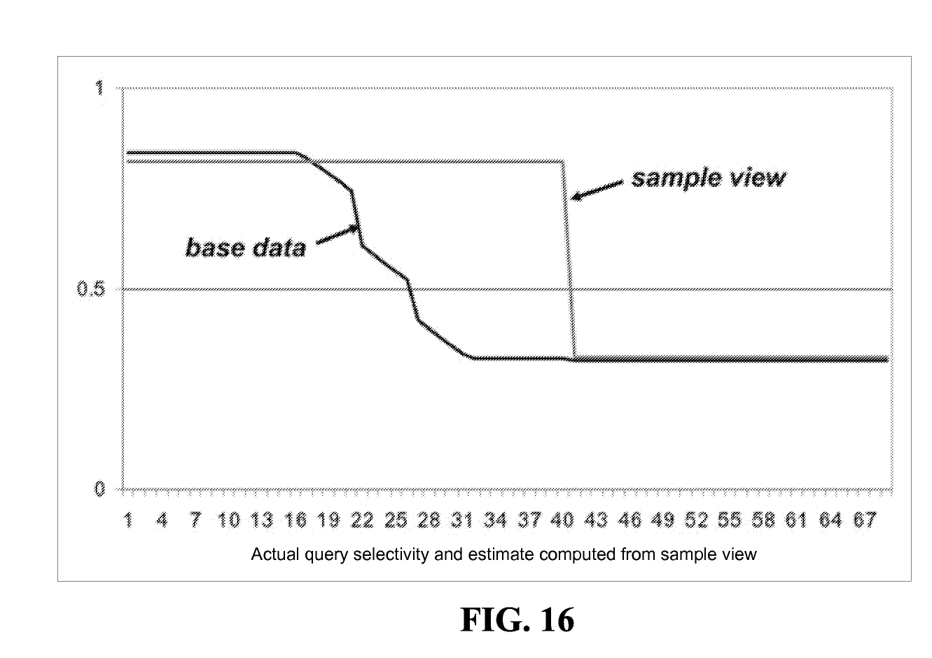

FIGS. 15 and 16 illustrate our quality control mechanism in action for the following simple scenario. The same query runs repeatedly. The selectivity of the query predicate was estimated from a sample view so the query reports the actual cardinality each time it runs. At iteration 16 in FIG. 15, an update transaction begins modifying the underlying base data in a way that has significant impact on the selectivity of the query. To demonstrate the effect more clearly, the queries run in read-uncommitted mode. After the start of the update, the queries begin reporting larger and larger errors, very quickly reaching the maximal value of 1.0. The exponentially smoothed average increases more slowly but as soon as it crosses the control bound, a refresh of the sample view is scheduled and (in this particular case) immediately executed. Queries continue to run while the sample is being refreshed and the average keeps on increasing. When the refresh is finished, E_{EWMA} is reset to its expected value of 0.5 and monitoring begins again. The query is also re-optimized and obtains a new estimate. Subsequent executions (after step 40) actually report a more accurate estimate than before the refresh.

FIG. 16 shows how the actual selectivity of the query predicate slowly changes as base data is updated. This change is reflected in the sample only later when the sample has been refreshed.

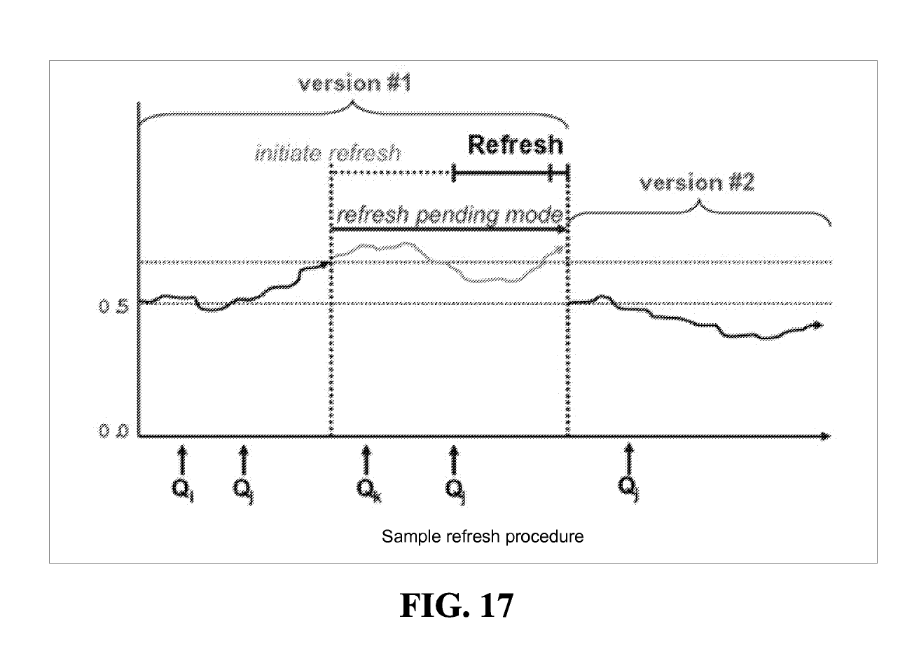

FIG. 17 shows a sample refresh is initiated by putting the sample view into refresh pending mode and creating a low-priority back-ground job to carry out the refresh. While a view is in refresh pending mode, queries may still use it for cardinality estimation (e.g. Qₖ in FIG. 17). However, the cardinality derivation process should be made aware that the estimates may not be accurate.

The background job performing the refresh is divided into two steps to minimize potential lock conflicts. In the first step, the sample is computed in read-uncommitted mode and temporarily stored in a staging table. A second step deletes the old content of the sample view and quickly copies in the sample from the staging table.

When a refresh completes, the version number of the sample is increased and the E_{EWMA} is reset to its expected value 0.5. We do not force recompilation of queries when a sample view is refreshed so queries compiled against an old version of the sample view may still execute and produce feedback information. Feedback from queries with an estimate based on an old version of a sample is ignored. This is the reason for including the sample version number in the InfoPack structure.

The statistical quality control mechanism implements a demand-driven refresh schedule. No longer is refresh activity triggered by heuristics based on the number updates or other simple metrics. Instead, the system adapts automatically to changing data but with a certain delay. How quickly the system responds depends on several factors.
How rapidly and how much the data changes.
How much the changes affect the cardinality of running queries. Changes that are not relevant to the query workload don't matter.
The accuracy of the estimators used. An estimator with a tighter error distribution makes the control system more sensitive to changes.
The smoothing factor α. The lower the value, the longer it takes for the system to react.
The control bound. The higher the control bound, the slower the system is to react (but the lower the probability of a false alarm).

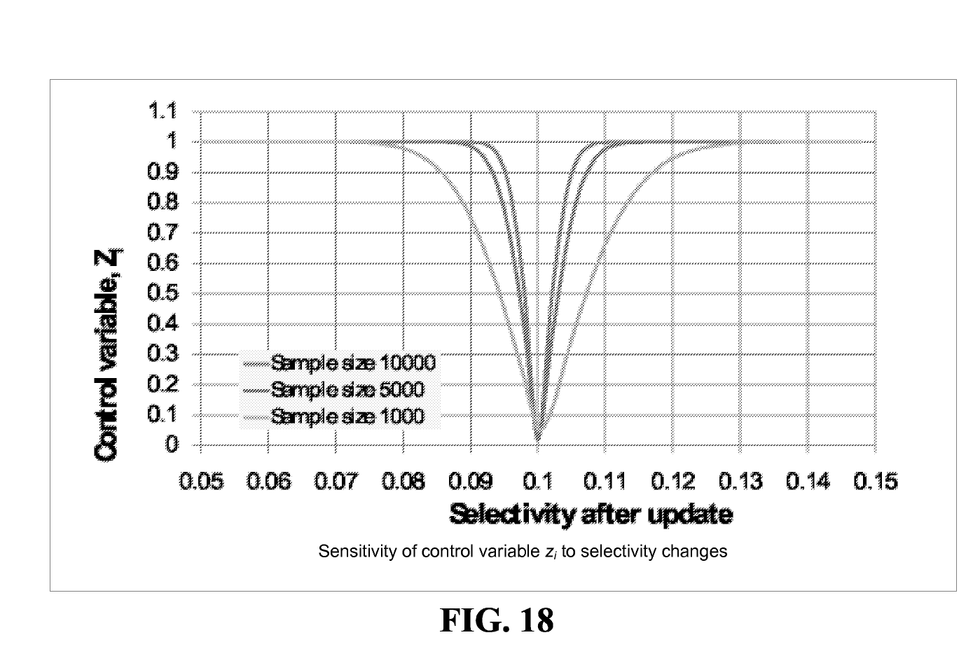

FIG. 18 illustrates how selectivity changes are reflected in the control variable zᵢ, that is, in the input to the control system. The example query has a original selectivity of 0.1 against a view of 1 million rows. Because observed estimation errors are normalized using the pdf of the estimator, the sensitivity of the control variable to changes in the selectivity depends on the effective sample size used when computing the estimate. The larger the sample, the tighter the distribution and the higher the sensitivity. Suppose the data is updated and the actual selectivity of the query changes to 0.11. If the estimate was computed from a sample of 1000 rows, this error is translated into a z-value of about 0.7. If the sample size was 10,000, the same error is mapped into a z-value of 1.

The control system is driven entirely by query feedback so its response time is measured in number of feedback reports received, not in absolute time. This provides an abstract aging model which is determined by the usage and not by the real world time line; a sample view is only as old as the number queries that have exploited it.

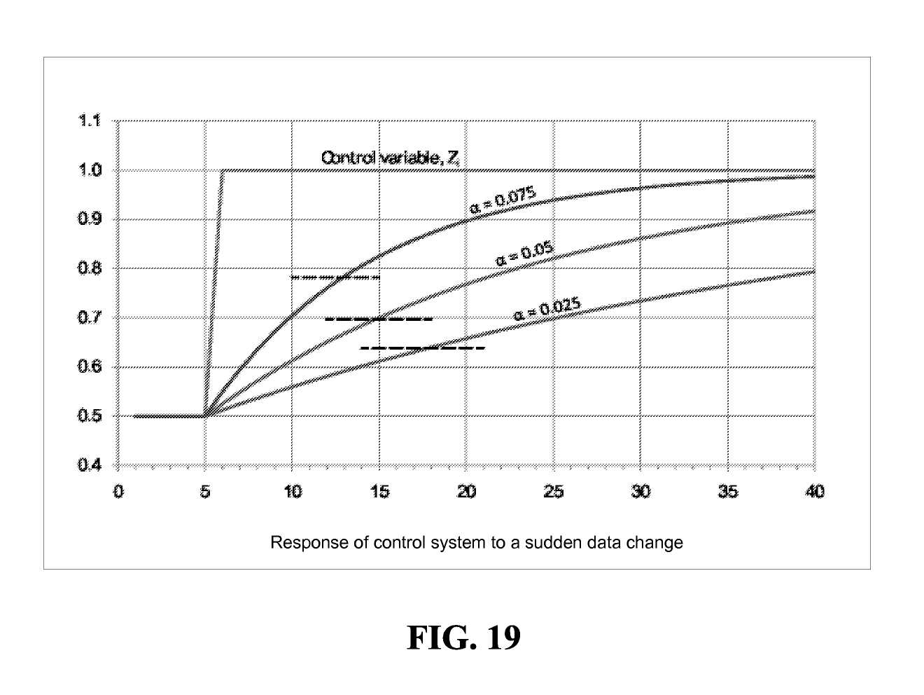

FIG. 19 shows how the system responds to a sudden change that is large enough to cause all feedback to be mapped into z-values of one. As we saw from the previous example, this doesn't necessarily require very large selectivity changes; even a change of one or two percentage points may be enough. How quickly the system responds depends on the smoothing constant α and the control bound. In the figure, the control bounds (the dashed lines) are set a 4.265 times the standard error, which corresponds to a risk of a false alarm of 10⁻⁵. In this scenario a refresh is triggered after 8 to 13 queries have reported, depending on the value of α.

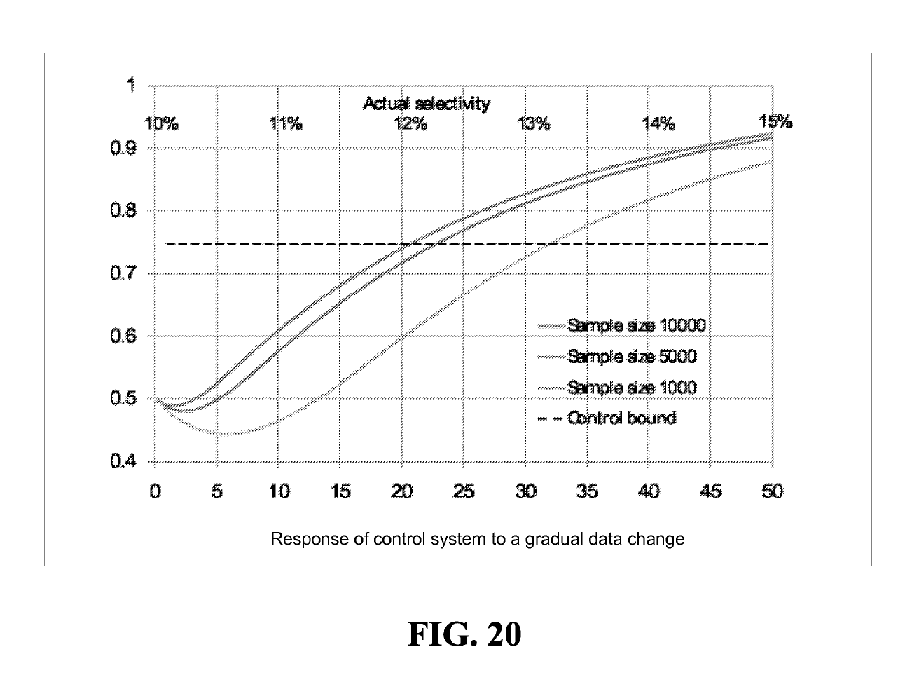

FIG. 20 illustrates the response to a gradual change in data and how it depends on the sample size. In this scenario we have a data set consisting of 1,000,000 rows and a query with a selectivity of 0.1, that is, 100,000 qualifying rows. Between each report the data is modified so that 1,000 additional rows qualify. So after 10 reports, there are 110,000 qualifying rows, after 20 there are 120,000 rows, and so on. The actual selectivity figures are shown across the top of the chart. The figure plots the effect of this gradual change on the exponentially smoothed average (α=0.04) for three different sample size. The larger the samples used, the higher the accuracy of the estimates, and the more rapidly the system reacts to data changes. For a sample size of 5,000, a refresh is triggered when the selectivity has increased by only two percentage points, from 10% to 12%. This level of sensitivity seems more than adequate; it is unlikely that a cardinality change from 100,000 to 120,000 rows would drastically affect the plan choice.

What has been described above includes examples of the disclosed and claimed subject matter. It is, of course, not possible to describe every conceivable combination of components and/or methodologies, but one of ordinary skill in the art may recognize that many further combinations and permutations are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system for estimating the results of a data analysis operation, comprising:
an sample view component that creates one or more sample views representing data on which the data analysis operation is intended to be performed, the one or more sample views contains a random sample of the data; and
an estimation component that performs an approximation of the data analysis operation on the one or more sample views to produce an estimated result of performing the data analysis operation on the data.

2. The system of claim 1, wherein the data analysis operation is a query or a subexpression of a query.

3. The system of claim 2, wherein the approximation of the data analysis operation is a probe query.

4. The system of claim 3, wherein the estimated result is a cardinality estimate.

5. The system of claim 4, further comprising an optimization component that employs the cardinality estimate to produce an optimized execution plan for the query.

6. The system of claim 5, further comprising a feedback component that produces feedback with the error between actual cardinality and the cardinality estimate each time the query is executed.

7. The system of claim 6, further comprising a sample quality control component that employs the feedback to determine when a sample view should be recreated.

8. The system of claim 7, wherein the sample quality control component triggers the sample view component to recreate the sample view when the error exceeds a threshold.

9. The system of claim 3, wherein a probe query employs sequential sampling against at least one sample view.

10. The system of claim 9, wherein a random identifier is assigned to each row of the at least one sample view, the at least one sample view is sorted by the random identifier.

11. The system of claim 10, wherein the probe query scans the at least one sample view until a stopping condition is met, the stopping condition is evaluated at each change in the random identifier, upon meeting the stopping condition the estimated result is output.

12. A method for estimating the results of a data analysis operation, comprising:
creating one or more sample views representing data on which the data analysis operation is intended to be performed, the one or more sample views contains a random sample of the data; and
performing an approximation of the data analysis operation on the one or more sample views to produce an estimated result of performing the data analysis operation on the data.

13. The method of claim 12, wherein the estimated result is a cardinality estimate of a query or a subexpression of a query.

14. The method of claim 13, further comprising employing the cardinality estimate to produce an optimized execution plan for the query.

15. The method of claim 14, further comprising producing feedback with the error between actual cardinality and the cardinality estimate each time the query is executed.

16. The method of claim 15, further comprising employing the feedback to recreate a sample view when the error exceeds a threshold.

17. The system of claim 12, further assigning a random identifier to each row of a sample view and sorting the sample view by the random identifier.

18. The method of claim 17, performing the approximation of the data analysis operation on the sample view until a stopping condition is met, wherein the stopping condition is evaluated at each change in the random identifier, and outputting the estimated result upon meeting the stopping condition.

19. A system for estimating the results of a data analysis operation, comprising:
means for creating one or more sample views representing data on which the data analysis operation is intended to be performed, the one or more sample views contains a random sample of the data; and
means for performing an approximation of the data analysis operation on the one or more sample views to produce an estimated result of performing the data analysis operation on the data.

20. The system of claim 19, further comprising:
means for producing feedback with the error between actual result and the estimated result each time the data analysis operation is executed on the data; and
means for employing the feedback to recreate a sample view when the error exceeds a threshold.
